(19) United States
(12) Patent Application Publication
(10) Pub. No.: US 2024/0116023 A1
(43) Pub. Date: Apr. 11, 2024

(54) NOVEL ACTIVATED CARBONS FOR SEQUESTERING CONTAMINATED COMPOUNDS

(71) Applicant: ADA Carbon Solutions, LLC, Greenwood Village, CO (US)

(72) Inventors: Micala Mitchek, Denver, CO (US); Joseph M. Wong, Castle Pines, CO (US); Robert Huston, Longmont, CO (US); Fred Cannon, State College, PA (US); David Park, Denver, CO (US); Lingyan Song, Englewood, CO (US); Mowen Li, Highlands Ranch, CO (US)

(21) Appl. No.: 18/459,921

(22) Filed: Sep. 1, 2023

Related U.S. Application Data
(60) Provisional application No. 63/403,626, filed on Sep. 2, 2022.
(60) Provisional application No. 63/431,555, filed on Dec. 9, 2022.

(51) Int. Cl. B01J 20/20; B01J 20/22; B01J 20/28

(52) U.S. Cl. CPC B01J 20/20; B01J 20/22; B01J 20/28059; B01J 20/28071; B01J 2220/46

(57) ABSTRACT

The present disclosure is directed to a multi-functional composition including activated carbon that is useful for injection into aqueous mediums such as soil or groundwater for sequestration of contaminants in a contaminated plume. The composition of activated carbon may include physical and chemical properties to enhance mechanism of contaminant physisorption and chemisorption including enhanced adsorption kinetics through manipulation of particle surface area, enhanced capacity and selectivity through controlled pore size distribution and enhanced electrostatic and hydrophobic interactions with contaminants. The multi-functional composition may further include a positively-charged nitrogen-functionalized organic compound and/or moieties that improve the activated carbon's ability to sequester contaminants in a subsurface environment.

### CROSS REFERENCES

This application claims priority to U.S. Provisional Patent Application No. 63/403,626, filed Sep. 2, 2022, entitled “NOVEL ACTIVATED CARBONS FOR SEQUESTERING CONTAMINANT COMPOUNDS FROM GROUNDWATER,” and U.S. Provisional Patent Application No. 63/431,555, filed Dec. 9, 2022, entitled “NOVEL ACTIVATED CARBONS FOR SEQUESTERING CONTAMINANT COMPOUNDS FROM GROUNDWATER,” which are incorporated herein by reference in their entirety.

### FIELD

This disclosure relates to the treatment of aqueous mediums (e.g., wastewater, ground water, etc.) or soil to remove contaminants (e.g., chlorinated solvents, petroleum hydrocarbons, polyfluoroalkyl compounds), and relates to sorbent compositions that are useful for such treatment, and to methods for making such sorbent compositions.

### BACKGROUND

Human activities have and continue to produce large quantities of waste materials and by-products across the world. Unfortunately, many of these man-made waste materials have been used, stored, or disposed of, in such a way where they seep into the underlying soil and groundwater.

Contaminated groundwater and soil can be hazardous to public health and have negative impacts on the environment. For example, contaminated groundwater can leach into water supplies, such as well drinking water, reservoirs, etc. and drinking or being exposed to such contaminated water can lead to various health issues, such as skin irritation, gastrointestinal disorders, central nervous system disorders, certain types of cancer, and the like. Soil contaminants from polluted land can cause many types of health issues ranging from minor symptoms such as skin irritation or nausea and more serious illnesses like cancer or even death.

Examples of groundwater and soil contaminates include chlorinated solvents, petroleum hydrocarbons, and per and polyfluoroalkyl substances (PFAS).

Chlorinated solvents are typically manufactured from naturally occurring hydrocarbon constituents (methane, ethane, and ethene) and chlorine through processes that substitute one or more chlorine atoms, or selectively dechlorinate chlorinated compounds to a less chlorinated state. These solvents have been used for a variety of commercial and industrial purposes, such as degreasers, drycleaning solutions, paint thinners, herbicides, pesticides, resins, glues, and a host of other mixing and thinning solutions. Chlorinated solvents tend to be colorless liquids at room temperatures, heavier than water, volatile, and sparingly soluble.

Chlorinated solvents include common groundwater contaminants and their degradation (breakdown products) such as vinyl chloride (VC), tetrachloroethylene (PCE) (also known as perchloroethylene or “PERC”), trichloroethylene (TCE), and dichloroethylene (DCE), which tend to enter the environment through evaporation, leaks, and improper disposal practices. Such contaminants tend to persist in the environment due to a combination of their physical and chemical properties (i.e., distribution coefficients, reactivity, solubility).

Since they generally have low solubility and are heavier than water, chlorinated solvents typically occur as dense nonaqueous phase liquids (DNAPLs) and tend to sink through both the unsaturated and unsaturated zone until they reach a confining layer. The DNAPL mass tends to dissolve slowly into the surrounding groundwater and thus, can result in a long-term source of groundwater contamination. Because of their high water solubilities relative to their Maximum Contaminant Levels (MCLs), even small spills of some solvents often result in widespread groundwater contamination. Chlorinated solvents, such as PCE and TCE are some of the most commonly identified organic chemicals in groundwater found at EPA Superfund sites. Chlorinated solvents in groundwater, particularly drinking water, can pose a potential threat to human health due to their mobility, longevity, and toxicity.

PFOA, PFOS and other PFASs are man-made chemicals that are widely used in a variety of industries such as aviation and aerospace, biocides, construction, household products, oil and mining production, and textiles, to name a few. For example, PFASs have been used to provide water, oil, and stain repellency to textiles, carpets, and leather, to create grease-proof and water-proof coatings for paper plates and food packaging, and to aid processing in fluoropolymer manufacturing among many other commercial and consumer applications.

Per and polyfluoroalkyl substances (PFAS) have been labeled “Forever Chemicals” because of their pervasiveness and the difficulty in removing these compounds from the environment. They are long lasting chemicals, components of which break down very slowly over time. Because of their widespread use and chemical and physical properties (persistence and mobility), PFOA, PFOS and other PFASs are easily leached into air, groundwater, surface waters (fresh, estuarine, and marine), and soils in the vicinity of their original source and at great distances. For example, PFOS and PFOA have been widely detected in surface water samples collected from various rivers, lakes, and streams in the United States and around the world. Scientific studies have shown that exposure to some PFAS in the environment may be linked to harmful health effects in humans and animals.

Petroleum hydrocarbons (PHCs) are the primary constituents in crude oil, gasoline, diesel, and a variety of solvents and penetrating oils. Petroleum hydrocarbon contamination is one of the most common environmental issues encountered. Because of the widespread use of petroleum fuels, a large number of the cleanup sites in at least the United States include PHC contamination. The nature of PHC contamination is highly variable since PHCs themselves are diverse mixtures of chemical components. Several aromatic hydrocarbons such as benzene, naphthalene, and chrysene are known or probable/possible human carcinogens and are classified as priority pollutants by the USEPA. Environmental pollution caused by releases of petroleum to land, surface water, or the subsurface is of concern because chemicals in PHCs can present a risk to human and environmental receptors if concentrations in environmental media are high enough.

Soil and groundwater remediation to remove contaminants from soil and groundwater sites that have been polluted by industrial, manufacturing, mining, or commercial activities is essential, if only to satisfy increasing regulatory standards for such contaminants.

### SUMMARY

These and other needs are addressed by the various embodiments and configurations of the present disclosure.

In some embodiments, a multi-functional composition includes activated carbon for removal of contaminants from an aqueous stream, such as groundwater or soil, or other effluent comprising liquid-phase contaminants. The composition includes diffusion pores, interior surfaces of which further include sequestration pores. The pore sizes of the diffusion and sequestration pores are selected to substantially maximize sequestration of the target contaminant. The diffusion pore size, for example, can be typically about 10 or more and more typically about 25 or more times larger than the molecular size of the target contaminant, and the sequestration pore size can be typically no more than about five and more typically no more than about 2.5 times the molecular size of the target contaminant. While not wishing to be bound by any theory, it is believed that the diffusion pores capture the target contaminant particles for adsorption by the sequestration pores through capillary action. Capillary action is the ability of a liquid to flow upward in narrow spaces without the assistance of external forces. In some applications, the pore size distribution is multi-modal (e.g., bimodal). Exemplary contaminants comprise hydrocarbons such as gasoline and diesel fuel from gas stations, organic compounds (e.g., volatile organic compounds such as aromatic hydrocarbons, chlorinated solvents, and polycyclic aromatic hydrocarbons, arsenic, aluminum, fluoride, nitrates, solvents, heavy metals, pharmaceuticals, radionuclides, and herbicides and pesticides.

In some embodiments, a multi-functional composition includes activated carbon (typically hydrophobic) and a positively-charged functionalized organic compound or moiety, such as a nitrogen-functionalized organic compound. Exemplary compounds include pyridine, pyridinium, quaternary ammonium, pyrrole, imines, pyrrolic nitrogen, imides, pyridinic nitrogen, secondary amine, tertiary amine, primary ketimine, secondary ketimine, primary aldimine, secondary aldimine, azide, azo compounds, pyridyl, hemoglobin, porphyrin, amine oxide, urea, and/or mixtures thereof. A carrier ion of the nitrogen-functionalized organic compound can be a halogen, halide, or interhalogen compound (e.g., chloride, bromide, fluoride, and/or iodide), methyl or dimethyl sulfate or an alkyl sulfate that is the monomethyl ester of sulfuric acid. In some embodiments, the functionalized organic compound comprises a quaternary amine surfactant having antimicrobial properties (e.g., able to kill bacteria, fungi and viruses). The functionalized organic compound can be added to the activated carbon or precursor thereof at elevated temperature or wet or dry mixed with the activated carbon at ambient temperature. While not wishing to be bound by any theory, it is believed that the functionalized organic compound is attracted to the activated carbon by a combination of van der Waals forces and pore adsorption.

The activated carbon can be in the form of colloidal, powdered, or granular activated carbon. Colloidal activated carbon typically has a D₅₀ size ranging typically from about 0.1 to about 10 μm and more typically from about 0.5 to about 5 μm and may be beneficial for in situ low pressure injection remediation applications. Powdered activated carbon typically has a D₅₀ size ranging typically from more than about 10 to about 350 μm and more typically from about 15 to about 200 μm and may be beneficial for in situ high pressure injection remediation application and incorporation into remediation amendments. Granular activated carbon typically has a D₅₀ size larger than powered activated carbon and may be beneficial for in situ trenched permeable reactive barrier for remediation applications, ex situ GAC vessel applications, and soil mixing.

The carbon can be used to remove in situ contaminants by injection, optionally under pressure, (such as by direct push technology, specialized injection well designs both vertically and horizontally, and hydro and pneumatic fracturing) into groundwater reservoirs, through in situ trenching, or treat contaminants above ground using ex situ or above-ground treatment systems, such as groundwater capturing excavations and vessels (pump-and-treat). The activated carbon can optionally be contacted with surface waters, such as ponds, lakes, rivers, streams, and the like using sediment remediation techniques.

The activated carbon can be adhered to or otherwise attached to a substrate, such as filtration cloth or other reactive or non-reactive (e.g., chemically inert) substrate.

The effluent to be treated can be predominantly liquid-phase by volume. Stated differently, the effluent typically comprises more than about 50% by volume liquid and even more typically more than about 75% by volume liquid. The effluent can comprise entrained particles, such as a slurry.

In one embodiment of the present disclosure, a multi-functionalized activated carbon sorbent comprises activated carbon particles, wherein: at least about 50% by weight of the activated carbon particles are less than about 2 micrometers, at least about 90% by weight of the activated carbon particles are less than about 4 micrometers, a particle number density of the multi-functionalized activated carbon sorbent is at least about a trillion particles per gram, and the external surface area density is at least about 1.5 square meters per gram.

In one embodiment of the present disclosure, a multi-functionalized activated carbon sorbent comprises activated carbon particles and a nitrogen functionalized organic compound, wherein: the nitrogen-functionalized organic compound hosts a positive charge throughout the pH range above about 8 pH units, and the nitrogen of the nitrogen functionalized organic compound links with at least two adjoining carbon atoms.

In one embodiment of the present disclosure, a multi-functionalized activated carbon sorbent comprises activated carbon particles and a rheology additive, wherein: at least about 50% by weight of the activated carbon particles are less than about 2 micrometers, at least about 90% by weight of the activated carbon particles are less than about 4 micrometers, a particle number density of the multi-functionalized activated carbon sorbent is at least about a trillion particles per gram, and the external surface area density is at least about 1.5 square meters per gram.

In one embodiment of the present disclosure, a method comprises contacting a multi-functionalized activated carbon sorbent comprising activated carbon particles with water to form a slurry; and injecting the slurry into a contaminated aqueous medium.

The multi-functionalized activated carbon sorbent may comprise one or more of a nitrogen functionalized organic compound and a rheology additive.

The ball pan hardness of the multi-functionalized activated carbon sorbent may be less than about 98 or is less than about 75.

The multi-functionalized activated carbon sorbent may comprise at least about 50 wt. % but not greater than about 95 wt. % of fixed carbon or at least about 50 wt. % but not greater than about 80 wt. % of fixed carbon.

The multi-functionalized activated carbon sorbent may comprise at least about 1.5 wt. % but not greater than 50 wt. % of minerals.

The multi-functionalized activated carbon sorbent may comprise at least about 10 wt. % but not greater than 50 wt. % of minerals.

The multi-functionalized activated carbon sorbent may comprise at least about 1 wt. % iron, at least about 1 wt. % calcium, and at least about 500 mg/kg titanium, on a dry weight basis.

A sum of micropore volume plus mesopore volume of the activated carbon particles may be at least about 0.2 cc/g. A ratio of micropore volume-to-mesopore volume of the activated carbon particles may be at least about 0.45 but not greater than about 1.9. A ratio of micropore volume-to-mesopore volume of the activated carbon particles may be at least about 0.45 but not greater than about 1.0.

A nitrogen-to-carbon mass ratio of the activated carbon particles may be at least about 3.2-to-1000, on a dry weight basis. A nitrogen-to-carbon mass ratio of the activated carbon particles may be at least about 5.0-to-1000, on a dry weight basis.

A thermogravimetric analysis (TGA) weight loss of the activated carbon particles, between about 400-750° C., may be less than about 4 weight percent. A TGA weight loss of the activated carbon particles may be less than about 2 weight percent between about 400-750° C., and may be at least about 1 wt. % between about 750-900° C.

The molecular weight of the nitrogen-functionalized organic compound may be less than about 8,000 Daltons.

The nitrogen-functionalized organic compound may be selected from the group comprising or consisting of pyridine, pyridinium, quaternary ammonium, pyrrole, imines, pyrrolic nitrogen, imides, pyridinic nitrogen, secondary amine, tertiary amine, primary ketimine, secondary ketimine, primary aldimine, secondary aldimine, azide, azo compounds, pyridyl, hemoglobin, porphyrin, amine oxide and/or mixtures thereof.

The nitrogen-functionalized organic compound may have a molecular weight of greater than about 200 Daltons.

The mass ratio of the activated carbon particles to the nitrogen-functionalized organic compound is between about 0.95:0.05 and about 0.05:0.95. The mass ratio of the activated carbon particles to the nitrogen-functionalized organic compound may be between about 0.9:0.1 and about 0.05:0.95. The mass ratio of the activated carbon particles to the nitrogen-functionalized organic compound may be between about 0.9:0.1 and about 0.25:0.75. The mass ratio of the activated carbon particles to the nitrogen-functionalized organic compound may be between about 0.75:0.35 and about 0.25:0.75.

The mass ratio of the activated carbon particles to the nitrogen-functionalized organic compound may be between about 0.95:0.05 to about 0.99995:0.00005. The mass ratio of the activated carbon particles to the nitrogen-functionalized organic compound may be between about 0.98:0.02 to about 0.9995:0.0001. The mass ratio of the activated carbon particles to the nitrogen-functionalized organic compound may be between 0.99:0.01 to about 0.995:0.005.

The carrier ion of the nitrogen-functionalized organic compound may be chloride, bromide, fluoride, iodide, methyl sulfate, or a combination thereof.

The nitrogen-functionalized organic compound may comprise an alkyl tail with between 6 and 24 carbon atoms.

The multi-functionalized activated carbon sorbent may comprise diffusion pores and sequestration pores having pore sizes selected based on a molecular size of a target contaminant particle.

The multi-functionalized activated carbon sorbent may comprise a charge selected based on a charge of a target contaminant particle.

The multi-functionalized activated carbon sorbent may comprise a hydrophobicity selected based on a hydrophobicity of a target contaminant particle.

The multi-functionalized activated carbon sorbent may comprise chemical and physical properties selected to sequester petroleum hydrocarbons, chlorinated solvents, polyfluoroalkyl substances, or a combination thereof.

At least about 50% by weight of the activated carbon particles are less than about 7 to 50 micrometers. At least about 50% by weight of the activated carbon particles are between about 200 to 5000 micrometers. At least about 50% by weight of the activated carbon particles are less than about 2 micrometers. At least about 90% by weight of the activated carbon particles are less than about 4 micrometers. A particle number density of the multi-functionalized activated carbon sorbent may be at least about a trillion particles per gram.

The external surface area density of the multi-functionalized activated carbon sorbent may be at least about 1.5 square meters per gram.

The multi-functionalized activated carbon sorbent may comprise water, and between about 15 and 40 wt. % of the activated carbon particles. The multi-functionalized activated carbon sorbent may comprise water, and between about 5 and 25 wt. % of the activated carbon particles.

The multi-functionalized activated carbon sorbent may comprise at least 90 wt. % of the activated carbon particles, or about 100 wt. % of the activated carbon particles.

The multi-functionalized activated carbon sorbent may comprises a rheology additive. The rheology additive may be utilized at a mass ratio of activated carbon particles to rheology additive between about 0.95:0.05 and about 0.50:0.50. The rheology additive and activated carbon particles may be in a solution comprising about 15 wt. % of the activated carbon particles and about 3 wt. % of the rheology additive. The rheology additive may be utilized at mass ratio of activated carbon particles to multi-functional rheology additive between about 0.90:0.10 and about 0.70:0.30. The rheology additive may be selected from the group comprising carboxymethyl cellulose (CMC), petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyl cellulose (HPC), Ethyl cellulose (EC), Carbomer (polyacrylic acid), and Guar.

Under typical groundwater concentrations, activated carbon pore volume and surface area are necessary but are not the only controlling properties required for adsorption of petroleum hydrocarbons, chlorinated solvents, and PFAS. The surface characteristics of activated carbon also play a critical role in controlling capture of the contaminants especially for less hydrophobic/more charged/more difficult to remove constituents.

The present invention can achieve a number of advantages depending on one or more target contaminants of interest. The present invention can provide a multi-functional composition comprising at least a base activated carbon material and, in some cases, a positively-charged organic compound tailored to target adsorption of one or more contaminants by controlling the chemical and/or physical properties of the multi-functional composition based on the chemical and/or physical properties of the target contaminant(s). Such a sorbent is not only effective in removing the targets contaminant(s) from groundwater and soil but also can be produced much more inexpensively and at a much higher yield than conventional activated carbon sorbents.

These and other advantages will be apparent from the disclosure of the aspects, embodiments, and configurations contained herein.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

A number of variations and modifications of the invention can be used. It would be possible to provide for some features of the invention without providing others. The embodiments and configurations described herein are neither complete nor exhaustive. As will be appreciated, other embodiments are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Absorption” is the incorporation of a substance in one state into another of a different state (e.g. liquids being absorbed by a solid or gases being absorbed by a liquid). Absorption is a physical or chemical phenomenon or a process in which atoms, molecules, or ions enter some bulk phase—gas, liquid or solid material. This is a different process from adsorption, since molecules undergoing absorption are taken up by the volume, not by the surface (as in the case for adsorption).

“Adsorption” is the adhesion of atoms, ions, biomolecules, or molecules of gas, liquid, or dissolved solids to a surface. This process creates a film of the adsorbate (the molecules or atoms being accumulated) on the surface of the adsorbent. It differs from absorption, in which a fluid permeates or is dissolved by a liquid or solid. Similar to surface tension, adsorption is generally a consequence of surface energy. The exact nature of the bonding depends on the details of the species involved, but the adsorption process is generally classified as physisorption (characteristic of weak van der Waals forces)) or chemisorption (characteristic of covalent bonding). It may also occur due to electrostatic attraction.

A “mill” refers to any facility or set of facilities that process a metal-containing material, typically by recovering, or substantially isolating, a metal or metal-containing mineral from a feed material. Generally, the mill includes an open or closed comminution circuit, which includes crushers or autogenous, semi-autogenous, or non-autogenous grinding mills.

A “sorbent” is a material that sorbs another substance; that is, the material has the capacity or tendency to take it up by sorption.

“Sorb” means to take up a liquid or a gas by sorption.

“Sorption” refers to adsorption and absorption, while desorption is the reverse of adsorption.

“Petroleum hydrocarbons” refer to the primary constituents in crude oil, gasoline, diesel, and a variety of solvents and penetrating oils, including but not limited to benzene, toluene, ethylbenzene, and xylenes (BTEX). Petroleum hydrocarbons may otherwise be referred to herein as BTEX compounds.

“Chlorinated solvents” refer to common groundwater contaminants and their degradation (breakdown products), including but not limited to vinyl chloride (VC), tetrachloroethylene (PCE) (also known as perchloroethylene or “PERC”), trichloroethylene (TCE), and dichloroethylene (DCE). Chlorinated solvents may otherwise be referred to herein as chlorinated volatile organic compounds (CVOCs).

“PFAS” as used herein refers to per and polyfluoroalkyl substances including but not limited to polyfluorooctanoic acid (PFOA), perfluorooctane sulfonic acid (PFOS), and perfluorobutane sulfonic acid (PFBS).

“Contaminants” as used herein, refers to contaminants found in contaminated soil and groundwater, including but not limited to petroleum hydrocarbons, chlorinated solvents, and per and PFAS.

“Sequestration pores” refer to micropores of a multi-functional composition of matter.

“Diffusion pores” refer to mesopores of a multi-functional composition of matter, and may otherwise be referred to a transportation pores.

“Activated carbon” or “AC” refers to an amorphous carbon that has been treated with steam and heat to exhibit strong affinity for adsorbing target contaminants.

“Fixed carbon” refers to the remaining carbon after carbonization process and the activation process, demonstrated by: % Fixed carbon=100%−(% volatile matter content−% ash content).

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

### BRIEF DESCRIPTION OF THE DRAWINGS

The accompanying drawings are incorporated into and forms a part of the specification to illustrate several examples of the present disclosure. These drawings, together with the description, explains the principles of the disclosure. The drawings simply illustrate preferred and alternative examples of how the disclosure can be made and used and is not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A depicts a plot of particle number density (y-axis) calculated for a range of activated carbon products (x-axis), according to an embodiment of the disclosure;

FIG. 1B depicts a plot of external surface area density (y-axis) calculated for a range of activated carbon products (x-axis), according to an embodiment of the disclosure;

FIG. 2A depicts a plot of cumulative pore volume distribution (y-axis) of activated carbon products over pore width (x-axis), according to an embodiment of the disclosure;

FIG. 2B depicts a plot of incremental pore volume distribution (y-axis) of activated carbon products over pore width (x-axis), according to an embodiment of the disclosure;

FIG. 3 depicts a plot of thermogravimetric analysis (TGA) of activated carbon, according to an embodiment of the disclosure;

FIG. 4A depicts a plot of round 1 adsorption isotherms for removal of chlorinated solvents, according to an embodiment of the disclosure;

FIG. 4B depicts a plot of round 2 adsorption isotherms for removal of chlorinated solvents, according to an embodiment of the disclosure;

FIG. 5 depicts a plot of round 2 adsorption isotherms for removal of hydrocarbons with activated carbon, according to an embodiment of the disclosure;

FIG. 6 depicts a plot of round 2 adsorption isotherms for removal of PFAS with activated carbon, according to an embodiment of the disclosure;

FIG. 7 depicts a plot of Freundlich Isotherm plots showing the adsorption performance of benzene, toluene, ethylbenzene, and xylenes (BTEX) to three different activated carbons in mixed-solute synthetic groundwater, according to an embodiment of the disclosure;

FIG. 8 depicts a plot of performance factor or relative dosage compared to lignite carbon needed to reach target equilibrium concentration, according to an embodiment of the disclosure;

FIG. 9 depicts a plot of Freundlich Isotherm plots from round 1 showing the adsorption performance of chlorinated volatile organic compounds (CVOCs) to the lignite activated carbon and the coconut activated carbon in mixed-solute synthetic groundwater, according to an embodiment of the disclosure;

FIG. 10 depicts a plot of Freundlich Isotherm plots from round 2 showing the adsorption performance of chlorinated volatile organic compounds (CVOCs) to the lignite activated carbon and the bituminous activated carbon in mixed-solute synthetic groundwater, according to an embodiment of the disclosure;

FIG. 11 depicts a plot of performance factors or dosage relative to lignite dosage needed to achieve the same target contaminant equilibrium concentration for all constituents and activated carbons, according to an embodiment of the disclosure; and

FIG. 12 depicts a plot of Freundlich Isotherm plots showing the adsorption performance of per and/or polyfluoroalkyl substances (PFAS) to three activated carbons, according to an embodiment of the disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

Various embodiments of a multi-functional composition of matter comprising activated carbon are provided that are particularly useful when applied (e.g., injected) to an aqueous stream, such as soil and/or groundwater, or other effluent comprising liquid-phase contaminants to rapidly and efficiently capture and remove contaminants. The composition of the multi-functional composition of matter and/or the activated carbon may include physical and chemical properties to enhance the mechanism of contaminant physisorption and chemisorption including enhanced adsorption kinetics through manipulation of particle surface area, enhanced capacity and selectivity through controlled pore size distribution, and enhanced electrostatic and hydrophobic interactions with contaminants.

Activated carbon particles of the multi-functional composition of matter may be uniform or vary in size. In embodiments, at least most (i.e., at least about 50 wt. %) of the activated carbon particles by weight are less than about 10 micrometers (μm), or more particularly less than about 8 μm, or more particularly less than about 5 μm, or more particularly less than about 4 μm, or more particularly less than about 3 μm, or more particularly less than about 2 μm. In embodiments, at least about 30 wt. %, or more particularly at least about 40 wt. %, or more particularly at least about 50 wt. % of the activated carbon particles are less than about 2 μm. In embodiments, at least about 50 wt. %, or more particularly at least about 60 wt. %, or more particularly at least about 70 wt. %, or more particularly at least about 80 wt. %, or more particularly at least about 90 wt. % of the activated carbon particles are less than about 4 μm. In embodiments, at least about 50 wt. % of the activated carbon particles are less than about 2 μm and at least about 90 wt. % of the activated carbon particles are less than about 4 μm.

The particle number density of the activated carbon particle of the multi-functional composition of matter is at least about a trillion particles per gram. The external surface area density of the multi-functional composition of matter is at least about 5 square meters per gram, or more particularly at least about 3 square meters per gram, or more particularly at least about 2 square meters per gram, or even more particularly about 1.5 square meters per gram. The particle number density and external surface area density may be determined by the Micromeritics Saturn DigiSizer II method, with computations assuming median representative spherical particles.

The multi-functional composition includes diffusion pores (i.e., transportation pores, mesopores), interior surfaces of which further include sequestration pores (i.e., micropores). The pore sizes of the diffusion and sequestration pores are selected to substantially maximize sequestration of the target contaminant(s). The diffusion pore size, for example, can be typically about 10 or more and more typically about 25 or more times larger than the molecular size of the target contaminant, and the sequestration pore size can be typically no more than about five and more typically no more than about 2.5 times the molecular size of the target contaminant. While not wishing to be bound by any theory, it is believed that the diffusion pores capture and transport the target contaminant particles for adsorption by the sequestration pores through capillary action. Capillary action is the ability of a liquid to flow upward in narrow spaces without the assistance of external forces. In some applications, the pore size distribution is multi-modal (e.g., bimodal).

In one characterization, the composition has a relatively high total pore volume and a well-controlled distribution of pores, particularly among the mesopores (i.e., from 20 Å to 500 Å width) and the micropores (i.e., not greater than 20 Å width). A well-controlled distribution of micropores and mesopores is desirable for effective removal of contaminants from a contaminated aqueous stream.

In this regard, the sum of micropore volume plus mesopore volume may be at least about 0.05 cc/g, such as at least 0.1 cc/g, at least about 0.2 cc/g. The micropore volume of the composition may be at least about 0.05 cc/g, such as at least about 0.1 cc/g, or at least about 1.5 cc/g. Further, the mesopore volume of the composition may be at least about 0.05 cc/g, such as at least about 0.1 cc/g, or at least about 0.15 cc/g. In an embodiment, the ratio of micropore volume to mesopore volume may be at least about 0.2, such as 0.3, 0.4, or 0.45 and may be not greater than about 2.0, such as 1.9, 1.5, and 1.0. Such levels of micropore volume relative to mesopore volume may advantageously enable efficient capture and sequestration of contaminant species by the multi-functional composition. Pore volumes may be measured using gas adsorption techniques (e.g., N₂ adsorption) using instruments such as a TriStar II Surface Area Analyzer 3020 or ASAP 2020 (Micromeritics Instruments Corporation, Norcross, GA, USA).

TGA weight loss measures the amount of oxygen functional groups on a carbon-based surface and may be an indicator of hydrophobicity. The higher the TGA weight loss, the higher the amount of oxygen functional groups and the more hydrophilic (or less hydrophobic) a carbon-based surface is. Lignite typically has a TGA weight loss less than about 4%, and more typically less than about 3%, and even more typically less than about 2%. Bituminous-based carbon typically has a TGA weight loss less than about 4%, more typically less than about 3%, more typically less than about 2%, and even more typically less than about 1%. In some embodiments, the activated carbon of the multi-functional composition of matter has a thermogravimetric analyzer (TGA) weight loss of less than about 6 wt. %, or less than about 5 wt. %, less than about 4 wt. %, less than about 3 wt. %, or less than about 2 wt. % (in the temperature range of about 400-750° C.). The activated carbon of the multi-functional composition may also have a TGA mass loss of at least 1 wt. % between about 750-900° C., under argon atmosphere.

The multi-functional composition may comprise a nitrogen-to-carbon mass ratio of at least about 3.2:1000, or more particularly about 1:500, more particularly at least about 1:400, more particularly at least about 1:300, or even more particularly at least about 1:200, on a dry weight basis. The nitrogen-to-carbon mass ratio may be measured by ASTM method D5373-04, or by any other known method.

The sorbent compositions disclosed herein may include other additives, e.g., additives for improving the efficacy of the sorbent compositions when applied in different operating conditions. In some embodiments, the multi-functional composition may further include a positively-charged organic compound and/or moieties that improve the activated carbon's ability to sequester contaminants in a subsurface environment. An example of the positively-charged organic compound is a nitrogen-functionalized organic compound. Accordingly, a multi-functional composition of the present disclosure includes activated carbon (typically hydrophobic) and a nitrogen functionalized organic compound, such as pyridine, pyridinium, quaternary ammonium, pyrrole, imines, pyrrolic nitrogen, imides, pyridinic nitrogen, secondary amine, tertiary amine, primary ketimine, secondary ketimine, primary aldimine, secondary aldimine, azide, azo compounds, pyridyl, hemoglobin, porphyrin, amine oxide, urea, and/or mixtures thereof. A carrier ion of the nitrogen-functionalized organic compound can be a halogen, halide, or interhalogen compound (e.g., chloride, bromide, fluoride, and/or iodide), methyl or dimethyl sulfate or an alkyl sulfate that is the monomethyl ester of sulfuric acid. In some embodiments, the functionalized organic compound comprises a quaternary amine surfactant having antimicrobial properties (e.g., able to kill bacteria, fungi and viruses). The functionalized organic compound can be added to the activated carbon or precursor thereof at elevated temperature or wet or dry mixed with the activated carbon at ambient temperature. While not wishing to be bound by any theory, it is believed that the functionalized organic compound is attracted to the activated carbon by a combination of van der Waals forces and pore adsorption.

In embodiments, the nitrogen-functionalized organic compound hosts a positive charge throughout the pH range above about 6 pH units, or above about 7 pH units, or above about 8 pH units. The nitrogen in the nitrogen-functionalized organic compound may link with at least two adjoining carbon atoms.

The molecular weight of the nitrogen-functionalized organic compound is less than about 10,000 Daltons, or more typically less than about 9,000 Daltons, or more typically less than about 8,000 Daltons. The nitrogen-functionalized organic compound may have a molecular weight of greater than about 50 Dalton, or more typically, greater than about 100 Daltons, or more typically greater than about 200 Daltons. Stated differently, the nitrogen-functionalized organic compound has a molecular weight between about 50 and 10,000 Daltons, or between about 100 and 9,000 Daltons, or between about 200 and 8,000 Daltons.

In embodiments of the present disclosure, the mass ratio of activated carbon to nitrogen-functionalized organic compounds is between about 0.9:0.1 to 0.05:0.95. The mass ratio of activated carbon to nitrogen-functionalized organic compounds is between about 0.75:0.35 to 0.25:0.75. In embodiments of the present disclosure, the concentration of the nitrogen-functionalized organic compounds in the multi-functional composition of matter may range between about 0 wt. % and 5 wt. %, or more particularly between about 0.05 wt. % and 3 wt. %, or more particularly between about 0.1 wt. % and 1 wt. %. In embodiments of the present disclosure, the concentration of the nitrogen-functionalized organic compounds in the multi-functional composition of matter may be less than about 5 wt. %, or less than about 4 wt. %, or less than about 3 wt. %, or less than about 2 wt. %, or less than about 1 wt. %. In embodiments of the present disclosure, the concentration of the nitrogen-functionalized organic compounds in the multi-functional composition of matter may be greater than about 0 wt. %, or greater than about 0.5 wt. %, or greater than about 1 wt. %.

In embodiments, the nitrogen-functionalized organic compound will include an alkyl tail with 6 to 24 carbon atoms.

The multi-functional composition may leach less than about 5%, or less than about 4%, or less than about 3%, or less than about 2% and not more than about 60%, or not more than about 50%, or not more than about 40%, or not more than about 30% of its mass, on a dry basis. The percent lost may be measured by Organic Leaching Tests, or any other known method.

Other additives to sorbent compositions that are known to those skilled in the art may be included within the sorbent compositions disclosed herein without departing from the scope of the present disclosure.

In one embodiment, the activated carbon of the multi-functional composition of matter may be derived from coal, and in particular may be derived from lignite coal, bituminous coal, sub-bituminous coal, or a combination thereof. In some embodiments, the multi-functional composition of matter may include mostly lignite-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % lignite-based carbon. In some embodiments, the multi-functional composition of matter may include mostly bituminous-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % bituminous-based carbon. In some embodiments, the multi-functional composition of matter may include mostly sub-bituminous-based activated carbon, where the activated carbon of the multi-functional composition comprises at least about 50 wt. %, or more particularly at least about 60 wt. %, or more particularly at least about 70 wt. %, or more particularly at least 80 wt. %, or more particularly at least about 90 wt. %, or more particularly about 100 wt. % sub-bituminous-based carbon. In some embodiments, the multi-functional composition of matter may comprise a mixture of lignite-based carbon and bituminous and/or sub-bituminous based carbon. For example, the multi-functional composition of matter may comprise mostly lignite-based coal (i.e., at least about 50 wt. %, or at least about 60 wt. %, at least about 70 wt. %, at least about 80 wt. %, at least about 90 wt. %) with the remaining percent being bituminous and/or sub-bituminous-based carbon. Alternatively, the multi-functional composition of matter may comprise mostly bituminous-based coal (i.e., at least about 50 wt. %, or at least about 60 wt. %, at least about 70 wt. %, at least about 80 wt. %, at least about 90 wt. %) with the remaining percent being lignite-based carbon and/or sub-bituminous-based carbon. Alternatively, the multi-functional composition of matter may comprise mostly sub-bituminous-based coal (i.e., at least about 50 wt. %, or at least about 60 wt. %, at least about 70 wt. %, at least about 80 wt. %, at least about 90 wt. %) with the remaining percent being lignite-based carbon and/or bituminous-based carbon.

The multi-functional composition of the present disclosure comprises at least about 30 wt. %, or more particularly at least about 40 wt. %, or more particularly at least about 50 wt. % of fixed carbon and not greater than about 100 wt. %, or more particularly not greater than about 95 wt. %, or more particularly not greater than about 90 wt. %, or more particularly not greater than about 80 wt. % fixed carbon. Stated differently, the multi-functional composition comprises between about 30-100 wt. % of fixed carbon, or more particularly between about 40-90 wt. % of fixed carbon, or even more particularly between about 50-80 wt. % of fixed carbon. The multi-functional composition of the present disclosure comprises at least about 1 wt. %, or more particularly about 1.5 wt. %, or more particularly about 2 wt. %, or more particularly at least about 5 wt. %, or even more particularly at least about 10 wt. % of minerals and not greater than about 80 wt. %, or more particularly not greater than about 70 wt. %, or more particularly not greater than about 60 wt. %, more particularly not greater than about 50 wt. % of minerals. Stated differently, the multi-functional composition comprises between about 2-80 wt. % of minerals, or more particularly between about 5-70 wt. % of minerals, or even more particularly between about 10-50 wt. % of minerals. Minerals included in the multi-functional composition may include aluminosilicates, metal oxides, metal carbonates, etc.

The multi-functional composition may comprise at least about 0.5 wt. % iron, or more typically at least about 1 wt. % iron on a dry weight basis. The multi-functional composition may comprise at least about 0.5 wt. % calcium, or more typically at least about 1 wt. % calcium on a dry weight basis. The multi-functional composition may comprise at least about 100 mg/kg titanium, or more typically at least about 300 mg/kg titanium, or more typically at least about 500 mg/kg titanium a dry weight basis.

Ball pan hardness provides a measure of the degradation resistance or “hardness” of activated carbons. The ball pan hardness of the multi-functional composition of the present disclosure is less than about 98, or more particularly less than about 90, or more particularly less than about 80, or more particularly less than about 85, or even more particularly less than about 75.

In another characterization, the activated carbon can be in the form of colloidal, powdered, or granular activated carbon, or combinations thereof. Colloidal activated carbon typically has a D₅₀ size ranging typically from about 0.1 to about 10 μm and more typically from about 0.5 to about 5 μm and may be beneficial for in situ low pressure injection remediation applications. Powdered activated carbon typically has a D₅₀ size ranging typically from more than about 10 to about 350 μm and more typically from about 15 to about 200 μm and may be beneficial for in situ high pressure injection remediation application and incorporation into remediation amendments. Granular activated carbon typically has a D₅₀ size larger than powered activated carbon and may be beneficial for in situ trenched permeable reactive barrier for remediation applications, ex situ granular vessel applications, and soil mixing. The D50 median average particle size may be measured using techniques such as light scattering techniques (e.g., using a Saturn DigiSizer II, available from Micromeritics Instrument Corporation, Norcross, GA).

In embodiments, the multi-functional composition in dry form (i.e., no water added) comprises at least about 90 wt. % of the activated carbon, or more particularly at least about 95 wt. % of the activated carbon, or more particularly about 100 wt. % of the activated carbon.

In embodiments, the multi-functional composition is combined with water to form a wet formulation of the multi-functional composition (i.e., a slurry). The wet formulation of the multi-functional composition may comprise between about 0 wt. % and 30 wt. % of activated carbon, or between about 1 wt. % and 20 wt. % of activated carbon, or between about 4 wt. % and 18 wt. % of activated carbon, or between about 6 wt. % and 15 wt. % of activated carbon. In some embodiments, the wet formulation of the multi-functional composition may comprise at least about 5 wt. % activated carbon, or more particularly at least about 10 wt. % activated carbon, or more particularly at least about 15 wt. % activated carbon, or more particularly at least about 20 wt. % activated carbon, or more particularly at least about 25 wt. % activated carbon, or more particularly at least about 30 wt. % activated carbon, or in some embodiments at least about 40 wt. % activated carbon, or in some embodiments at least about 50 wt. % activated carbon.

The weight percent of activated carbon included in the wet formulation may be based on the size of the activated carbon (i.e., granular versus powdered versus colloidal activated carbon). For example, the wet formulation comprising CCP may include a lesser weight percent of activated carbon as compared to a wet formulation comprising powdered activated carbon. In some embodiments, whether the multi-functional composition is combined with water is based on the activated carbon of the multi-functional composition. For example, a multi-functional composition comprising granular activated carbon may not be mixed with water. Similarly, a multi-functional composition comprising powdered activated carbon may be used in the dry form (i.e., with no added water) as well as in a wet form.

In another characterization, the multi-functional composition has a relatively high surface area. For example, the multi-functional composition may have a surface area of at least about 350 m²/g, such as at least about 400 m²/g or even at least about 500 m²/g. Surface area may be calculated using the Brunauer-Emmett-Teller (BET) theory that models the physical adsorption of a monolayer of nitrogen gas molecules on a solid surface and serves as the basis for an analysis technique for the measurement of the specific surface area of a material. BET surface area may be measured using the Micromeritics TriStar II 3020 or ASAP 2020 (Micromeritics Instrument Corporation, Norcross, GA).

In an embodiment, a method for the manufacture of the multi-functional composition of matter is disclosed.

The manufacturing process begins with a carbonaceous feedstock such as low-rank lignite coal, bituminous coal, sub-bituminous coal, or a combination thereof with a relatively high content of natural deposits of native minerals. The feedstock may be agglomerated by mixing the feedstock material and in some cases, crushing, compacting, or extruding the mixture. In the manufacturing process, the agglomerated feedstock is subjected to an elevated temperature and one or more oxidizing gases under exothermic conditions for a period of time to sufficiently increase surface area, create porosity, alter surface chemistry, and expose and exfoliate native minerals previously contained within feedstock. The specific steps in the process include: (1) dehydration, where the feedstock is heated to remove the free and bound water, typically occurring at temperatures ranging from 100-1500 C; (2) devolatilization, where free and weakly bound volatile organic constituents are removed, typically occurring at temperatures above 150° C.; (3) carbonization, where non-carbon elements continue to be removed and elemental carbon is concentrated and transformed into random amorphous structures, typically occurring at temperatures around the 350-800° C.; and (4) activation, where steam, air or other oxidizing agent is added and pores are developed, typically occurring at temperatures above 800° C. The manufacturing process may be carried out, for example, in a multi-hearth or rotary furnace. The manufacturing process is not discrete and steps can overlap and use various temperatures, gases and residence times within the ranges of each step to promote desired surface chemistry and physical characteristics of the manufactured product. The activated carbon product is then discharged and may be cooled via passivation.

After activation, the product may be subjected to a comminution step to reduce the particle size (e.g., the median particle size) of the product. Comminution may occur, for example, in a mill such as a roll mill, jet mill, ball mill or other like process. Comminution may be carried out for a time sufficient to reduce the median particle size of the thermally treated product to not greater than about 3 micron (for CCP). In some embodiments, the comminution may be carried out to achieve a median particle size not greater than about 30 micron, or between about 12 and 30 micron, or greater than about 12 micron (for powdered activated carbon). In some embodiments, the comminution may be carried out to achieve a median particle size not greater than about 2400 micron, or between about 590 to 2400 microns, or greater than about 590 microns (for granular activated carbon). In some embodiments, the sizing may be performed via the use of sieves (8×30 or 12×40 for granular activated carbon), and/or via grinding. In some embodiments, the biproduct of granular activated carbon production may be used for powered activated carbon or CCP production.

In some embodiments, the activated carbon can be adhered to or otherwise attached to a substrate, such as filtration cloth or other reactive or non-reactive (e.g., chemically inert) substrate.

In some embodiments, the multi-functional composition of matter comprises a positively charged organic compound(s), such as a nitrogen-functionalized organic compound or moiety. The multi-functional composition comprises an effective amount of one or more of the positively charged organic compound(s) to effectuate the removal of contaminants from an aqueous medium (e.g., soil, groundwater). In one characterization, the multi-functional composition comprises at least about 0.1 wt. % of a positively charged organic compound, such as at least about 1 wt. %, such as at least about 3 wt. %, or at least about 5 wt. % of the positively charged organic compound(s). However, too high of a concentration of the positively charged organic compound may not increase the capacity or efficiency of contaminant sequestration, and may even be detrimental. In once characterization, the concentration of the positively charged organic compound in the multi-functional composition is not greater than about 50 wt. %, such as not greater than about 30 wt. %, such as not greater than about 20 wt. %, or even not greater than about 10 wt. %. In some embodiments, the mass ratio of activated carbon to nitrogen-functionalized organic compounds is between about 0.9:0.1 to about 0.05:0.95 or between about 0.75:0.35 to about 0.25:0.75.

Various techniques may be used to combine the base carbon material of the multi-functional composition with the positively charged organic compound. For example, the positively charged organic compound will typically be in the form of a solution and/or slurry, such as by dissolving the positively charged organic compound in water. The solution and/or slurry may then be brought into contact with the base carbon material to coat and/or impregnate the base carbon material with the solution and/or slurry. One such technique is the incipient wetness technique, wherein the solution is drawn into the pores of the base carbon material via capillary action. Other techniques include spraying the positively charged organic compound solution and/or slurry onto the base carbon material, impregnating the base carbon material by soaking it in the solution and/or slurry followed by washing steps, reacting the positively charged organic compound to the surface of the base carbon material, or immobilizing the positively charged organic compound on the base carbon material's surface. Another technique involves injecting the positively charged organic compound into the liquid, where it would form complexes with the contaminants in solution to subsequently be absorbed by the base carbon material. In any case, the solution may be dried, if necessary, to remove excess liquid and/or to crystallize the positively charged organic compound.

In an alternative embodiment, the positively charged organic compound may be provided in a substantially dry form (e.g., as particulates) and may be admixed with the base carbon material, such as by combining the two particular components in a mill or in a mixing unit.

In one embodiment, the base carbon material may be combined with the positively charged organic compound before or after activation of the base carbon material.

In some embodiments, a rheology additive may be applied to the activated carbon product after activation, either before or after cooling. To apply the rheology additive to the carbon, the rheology additive may be dissolved in water or some other solvent to form a rheology additive solution, and the carbon may be added to the solution, and the combined solution may be wet ball milled. The rheology additive works to disperse the particles and may act as a lubricant during the milling process. The rheology additive may be particularly utilized with carbon in CCP form, but may be added to carbon of any form, such as granular or powdered carbon.

In embodiments, a multi-functional rheology additive is utilized at mass ratio of activated carbon to multi-functional rheology additive between about 0.95:0.05 to 0.50:0.50. In embodiments, a multi-functional rheology additive is utilized at mass ratio of activated carbon to multi-functional rheology additive between about 0.90:0.10 to 0.70:0.30. In embodiments, the rheology additive is combined in solution with the activated carbon particles, where the solution comprises between about 5 wt. % and 30% of the activated particles, and more particularly about 15 wt. % of the activated carbon particles, and between about 0 wt. % and 10 wt. % of the rheology additive, and more particularly about 3 wt. % of the rheology additive.

The multi-functional rheology additive may be selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyl cellulose (HPC), Ethyl cellulose (EC), Carbomer (polyacrylic acid), and Guar.

In some embodiments, a quaternary amine additive, such as carbon-alkyl dimethyl benzyl ammonium chloride, may be applied to the activated carbon product after activation, either before or after cooling. The quaternary amine additive has a positive charge that can act to attract negatively charged or negatively polar contaminates. In embodiments, the quaternary amine additive may be applied to the carbon via spray loading or otherwise by dissolving the additive in water or some other solvent to form a quaternary amine additive solution, and the carbon may be added to the solution. The combined solution may be wet ball milled. The quaternary amine additive may be particularly utilized with carbon in CCP form, but may be additive to carbon of any form, such as granular or powdered carbon.

The activated carbon may be spray-loaded with at least about 10 wt. %, or more particularly at least about 15 wt. %, or even more particularly at least about 20 wt. % of 12 to 18 carbon-alkyl dimethyl benzyl ammonium chloride. After being spray-loaded, the activated carbon will subsequently leach off at least about 10% and not more than about 70% of the additive when subjected to deionized water for about one week under particular leaching conditions.

An embodiment of the present disclosure comprises a method of producing small grains of activated carbon for soil and/or groundwater remediation (e.g., via injection) using a wet ball mill process that yields a multi-functional composition as disclosed herein.

The multi-functional compositions disclosed herein are particularly useful for the sequestration of contaminants from a contaminated medium, such as soil or groundwater. Thus, the present disclosure also encompasses a method for the treatment of an aqueous medium to remove contaminants from the aqueous medium by contacting the aqueous medium with the multi-functional composition such as those disclosed herein. In an embodiment, a method for the application (e.g., use) of the multi-functional composition of matter is disclosed. To facilitate the removal of contaminants from an aqueous medium, the method includes contacting the aqueous medium with the multi-functional composition of matter disclosed herein. In some embodiments, a positively-charged organic compound may be combined with the multi-functional composition of matter, e.g., before being contacted with the aqueous medium, as is discussed above. Alternatively, the positively-charged organic compound may be dispersed into the aqueous medium before or during contact of the aqueous medium with the multi-functional composition, e.g., with a base carbon material that has not been combined with the positively-charged organic compound.

As is known to those of skill in the art, the multi-functional composition including the base carbon and, in some embodiments, the positively-charged organic compound may be contacted with the aqueous medium (e.g., waste stream) to remove contaminants (e.g., petroleum hydrocarbons, chlorinated solvents, PFAS, and the like) in a wide variety of ways. For example, the multi-functional composition may applied to a contaminated site via injection (such as by direct push technology, specialized injection well designs both vertically and horizontally, and hydro and pneumatic fracturing), in situ trenching, or applied via ex situ or above-ground treatment systems, or the like. The multi-functional composition may be placed in a cartridge, column, or similar structure through which the aqueous medium flows or rests. In another example, the multi-functional composition may be placed on or within a membrane (e.g., a planar membrane) through which the aqueous medium flows or rests. The activated carbon can be adhered or otherwise attached to a substrate, such as filtration cloth or other reactive or non-reactive (e.g., chemically inert) substrate. The multi-functional composition may also be shaped into an integral structure (e.g., a honeycomb structure, porous carbon blocks) or may be incorporated into such a structure (e.g., a ceramic honeycomb structure). The multi-functional composition may also be used in a permeable reactive barrier, such as where the multi-functional composition is either buried in a trench or is injected into the subsurface to treat contaminated groundwater. The multi-functional composition may also be applied to contaminated soil through mechanical mixing (e.g., tilling or plowing).

In some embodiments, the method used to apply the multi-functional composition may be based on the size of the activated carbon particles in the multi-functional composition. For example, injection may be particularly useful for multi-functional compositions comprising powered and colloidal activated carbon. The injection pressure may also be based on the size of the activated carbon particles in the multi-functional composition. For example, a multi-functional compositions comprising PAC may require a higher injection pressure than a multi-functional compositions comprising CCP (assuming they are being injected to the same location underground). Multi-functional compositions comprising granular, powdered, or colloidal activated carbon may be trenched, but granular activated carbon may be particularly useful for trenching.

The application techniques described herein to apply the multi-functional composition to a contaminated site may be used alone or in various combinations. In some embodiments, multi-functional compositions comprising the same or different sizes of activated carbons (i.e., PAC, GAC, CCP) may be used in combination at a contaminated site. For example, a multi-functional composition comprising activated carbon of a first size may be trenched at a particular location, and a multi-functional composition comprising activated carbon of a second size may be injected at the same location or a different location, where the first and second sizes are the same or different. In another example, a multi-functional composition comprising activated carbon of a first size may be trenched at a particular location and a multi-functional composition comprising activated carbon of a second size may also be trenched at the same location or at a different location, where the first and second sizes are the same or different. If being trenched at the same location, the two multi-functional compositions may be trenched at the same time or at different times (e.g., double treatment). In another example, a multi-functional composition comprising activated carbon of a first size may be injected at a particular location and a multi-functional composition comprising activated carbon of a second size may also be injected at the same location or at a different location, where the first and second sizes are the same or different. If being injected at the same location, the two multi-functional compositions may be injected at the same time or at different times (e.g., double treatment). Additionally, the two multi-functional compositions may be injected with the same injection pressures or different injection pressures.

In some embodiments, the multi-functional compositions comprising activated carbons of the first and second sizes may be combined before being applied to a contaminated site, or applied to the contaminated site separately.

In a non-limiting example, a multi-functional composition comprising granular activated carbon and/or powdered activated carbon may be trenched into the ground near or at the source of the contamination which may serve as a barrier to limit the spread of the contaminant and to assist cleanup efforts. Additionally, one or more other multi-functional compositions may be injected into source contamination area and/or the surrounding contaminated areas, where the multi-functional compositions may comprise powdered and/or colloidal activated carbon.

In another non-limiting example, a multi-functional composition comprising CCP may be injected at a location via a first injection pressure and multi-functional composition comprising PAC may be injected at the same location via a second injection pressure, wherein the first injection pressure is greater than the second injection pressure. The CCP and PAC multi-functional compositions may mix underground. In another non-limiting example, a multi-functional composition comprising CCP may be mixed with multi-functional composition comprising PAC. The mixed multi-functional compositions may then be applied to a contaminated site, such as by injection. The mixed multi-functional composition may be applied to the contaminated site once or multiple times and/or via different techniques. For example, the mixed multi-functional compositions be injected at a location via a first injection pressure and may be injected at the same location via a second injection pressure, wherein the first injection pressure is greater than the second injection pressure, or vice versa. In such cases, the CCP and PAC multi-functional composition may reach different depths in the ground.

An embodiment of the present disclosure comprises a method to remediate groundwater by providing a slurry of water and a multi-functional composition of matter of the present disclosure.

The slurry may comprise a multi-functional rheology additive and/or dispersion aid at mass ratio of activated carbon to multi-functional rheology additive between about 0.95:0.05 to 0.50:0.50. In some embodiments, the slurry may also comprise a multi-functional rheology additive and/or dispersion aid at mass ratio of activated carbon to multi-functional rheology additive between about 0.90:0.10 to 0.70:0.30. The multi-functional rheology additive and/or dispersion aid may be selected from the group comprising carboxymethyl cellulose, petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyle cellulose (HPC), Ethyl cellulose (EC), Carbomer (polyacrylic acid), and Guar.

The effluent to be treated can be predominantly liquid-phase by volume. Stated differently, the effluent typically comprises more than about 50% by volume liquid and even more typically more than about 75% by volume liquid. The effluent can comprise entrained particles, such as a slurry.

The multi-functional composition is injected into the ground as a slurry that is comprised of the composition of matter plus water.

In certain characterizations, the multi-functional compositions disclosed herein have a relatively high capacity for contaminant removal. In one embodiment, the multi-functional compositions have a capacity to capture at least about 1 mg contaminant per gram of multi-functional composition (mg C/g), such as at least about 2 mg C/g, at least about 5 mg C/g, at least about 7.5 mg C/g, at least about 10 mg C/g, at least about 15 mg C/g, or even at least about 20 mg B/g. However, it should be understood that removal capacity of the multi-functional compositions may vary widely depending on the target contaminant, the target contaminant concentration, any other present contaminants and their concentrations.

An embodiment of the present disclosure is directed to multi-functional compositions of matter, methods for making the multi-functional composition, and methods for using the multi-functional composition (e.g., to selectively remove one or more target contaminants from contaminated media, such as groundwater and soil). Exemplary contaminants typically found in soil and groundwater comprise hydrocarbons such as gasoline and diesel fuel from gas stations, organic compounds (e.g., volatile organic compounds such as aromatic hydrocarbons, chlorinated solvents, and polycyclic aromatic hydrocarbons, arsenic, aluminum, fluoride, nitrates, solvents, heavy metals, pharmaceuticals, radionuclides, and herbicides and pesticides.

Different contaminants, however, may be associated with different characteristics that may impact a contaminant's sequestration into the multi-functional composition, such as hydrophobicity, size, charge, etc. To improve the efficiency of sequestering contaminants, methods of the present disclosure are directed to understanding a contaminants controlling mechanisms and then integrating associated physiochemical functionalities with activated carbons based on the properties of a target contaminant(s).

In this regard, to achieve improved efficiency, if the contaminant of interest is positively charged, the multi-functional composition should be negatively charged so the contaminant is attracted to the multi-functional composition of matter. Additionally, if the contaminant of interest is relatively hydrophobic, then the multi-functional composition of matter should also be hydrophobic, and similarly the multi-functional composition should be hydrophilic for hydrophilic contaminants. In terms of size, typically, sequestration and transport pores of the multi-functional composition of matter should be about 1-2 times and up to 10 times the contaminant's molecular diameter. The chemical and physical properties of a multi-functional composition of matter for the sequestration of contaminants work with and against each other.

For example, the surface functionality of a multi-functional composition may affect the sequestration of a particular contaminant more than the pore structure of the multi-functional composition. Similarly, chemical and physical characteristics of a contaminant may not be weighted of equal importance. For example, contaminant size may play a more significant role than charge in terms of capturing a particular contaminant, whereas charge may play a more significant role than hydrophobicity in capturing another contaminant. Therefore, there is often a balancing act in manufacturing a multi-functional composition of matter for the sequestration of one or more target contaminants.

In terms of the carbon used in the muti-functional composition, lignite is inherently more hydrophilic compared to bituminous and coconut based carbon, and bituminous is considered very hydrophobic. With reference to charge, lignite, bituminous, and coconut based carbon are all inherently positively charged. Where coconut-based carbons are generally dominated by micropores, both lignite and bituminous-based carbons typically have a distribution of micro and mesopores. Generally, lignite-base carbons have a larger proportion of mesopores compared to micropores and vice versa for bituminous-based carbons. Lignite may have the advantage over other carbon sources in terms of pore ratio for contaminant transportation, but the disadvantage in that the micropore volume is lower than bituminous-based carbon. However, the surface functionality of bituminous is much lower than lignite which makes the bituminous surface very hydrophobic compared to lignite.

Chlorinated solvents, such as tetrachloroethylene (PCE), trichloroethylene (TCE), dichloroethylene (DCE), and vinyl chloride (VC), typically range in size from about 4.7 to about 5.1 Å, and they range in hydrophobicity. For example, VC and DCE are relatively less hydrophobic (i.e., somewhat hydrophilic, with log K_{OW} values of about 1.6 and 1.5, respectively), whereas PCE and TCE are relatively more hydrophobic (with K_{OW} values of about 3.4 and 2.5, respectively). Additionally, chlorinated solvents are typically negatively polar.

To note, Log K_{OW} is an important parameter for predicting the distribution of a substance in various environmental compartments (e.g., water, soil, air, biota, etc.). Substances with high log K_{OW} values tend to adsorb more readily to organic matter in soils or sediments because of their low affinity for water.

Petroleum hydrocarbon contaminants such as benzene, toluene, ethylbenzene, and xylenes typically range in size from about 5.8 to about 6.4 Å, are positively charged, and are considered hydrophobic (ranging from about 2.1 to 3.2 on a log K_{OW} scale).

PFAS contaminants, such as perfluorooctanoic acid (PFOA), perfluorooctane sulfonic acid (PFOS), and perfluorobutane sulfonic acid (PFBS), typically range in size from about 7×10 Å to about 8×13 Å, putting them on the larger side of soil and groundwater contaminants. PFAS contaminants are negatively charged or negatively polar (under most pH conditions), and range in hydrophobicity of about 2.6 (considered hydrophobic) to about 5.6 (considered very hydrophobic).

Hydrophobic contaminants of interest typically have a molecular diameter in the range of 4 to 13 angstroms (Å). Thus, desirable sequestration pore volume of the activated carbon is in the micropore (0-20 Å) range. Also important, is transportation pore volume (typically in the mesopore (20-500 Å) range) to aid in the diffusion of the contaminant to the sequestration pores.

Particularly important in driving chemisorption mechanism may be the nitrogen content of the activated carbon. Nitrogen can be positively charged, and thus beneficial for removing negatively charged or negatively polar species, such as chlorinated solvents, per and polyfluoroalkyl substances, polychlorinated biphenyls, and/or oxyanions. Also important for imbedding positively charged or positively polar functionality and/or anion exchange sites into the activated carbon surface may be calcium, iron, aluminum, magnesium, manganese, titanium, strontium, sodium, and potassium. A positively-charged nitrogen-functionalized organic compound is useful for providing a positively charged site to interact with negatively charged or negatively polar contaminants such as per and polyfluoroalkyl substances, chlorinated solvents, polychlorinated biphenyls and/or oxyanions Surface oxygen functional groups may also drive chemisorption. The type of surface oxygen functionality can be inferred from the decomposition temperature and from the form of gas that evolved (CO2 or CO). Surface oxygen functionality can impact adsorption in multiple ways. First, the surface oxygen functional groups create a more polar or more hydrophilic surface which is undesirable for hydrophobic contaminants, such as per and polyfluoroalkyl substances, hydrocarbons, polychlorinated biphenyls, and/or chlorinated solvents. Second, the functional groups can cause steric hinderance impacts by blocking access to adsorption sites. Finally, they can impact the activated carbon's surface charge and charge distribution. For example, most oxygen functional groups are acidic leading to a more negative surface charge. For negatively charged or negatively polar contaminants, a more positive surface is desirable. The charge of the activated carbon surface may also be important for impacting the mobility of the activated carbon in the subsurface as a positively charged surface would be attracted to the soil (which generally holds a net negative charge) whereas a negatively charged activated carbon surface would be repelled.

For a less hydrophobic/more polar molecule, the surface charge may be particularly important for attracting negatively charged or negatively polar species. An activated carbon surface with less oxygen functional groups may be more hydrophobic for attracting hydrophobic constituents.

Generally for petroleum hydrocarbon contaminates, the performance ranking from most effective or lowest dosage rate to the least effective or highest dosage is as follows bituminous>lignite>coconut. The trend does not track what would be observed if adsorption was controlled by sequestration or total pore volume, or by surface hydrophobicity alone. Instead, adsorption performance is controlled by a combination of factors including both pore volume distribution and surface chemistry. Superior performance of bituminous AC was identified for BTEX compounds. The properties of this bituminous AC, particularly the highly hydrophobic surface character and the multi-modal pore volume distribution, enhanced the adsorption capacity for BTEX compounds.

For CVOCs, there is a trend of increasing performance advantage of the lignite AC as the CVOC constituents get less hydrophobic. The less hydrophobic constituents are also the more difficult to sequester and have lower total adsorption capacity on a particular AC. Generally, the performance ranking from most effective or lowest dosage rate to least effective or the highest dosage is as follows lignite>bituminous>coconut, concurring with a trend of increasing ASTM pH and cationic surface functionality. The trend is opposite of what would otherwise be observed if adsorption was controlled purely by sequestration or total pore volume. Instead, indicating that AC surface chemistry is also important for driving enhance adsorption performance for CVOC constituents.

Superior performance of lignite AC was identified especially for less hydrophobic and/or more polar CVOCs indicating a selectivity for these more difficult to remove contaminants. The properties of the AC surface of this lignite AC, particularly the positively charged functionality, enhanced the adsorption selectivity for the more negatively polar species. The transport pores also may serve to minimize the impact of competitive adsorption from more strongly adsorbing and/or more hydrophobic constituents.

For PFAS, there are two distinct performance trends for each long-chain (PFOS and PFOA) versus short-chain (PFBS) constituents. The long-chain PFAS compounds are more hydrophobic and more adsorbable by AC. Generally, the performance ranking for the long-chain compounds from most effective or lowest dosage rate to least effective or the highest dosage is as follows bituminous>lignite>coconut. The trend does not track what would be observed if adsorption was controlled by sequestration or total pore volume, instead indicating that performance is controlled by a combination of factors including surface chemistry. For the short chain compound, performance of lignite is superior to both bituminous and coconut, indicating an even larger dependence on surface chemistry of the AC for the less hydrophobic/more charged compounds.

Superior performance of bituminous AC was identified for long-chain PFAS compounds. The properties of this AC, particularly the highly hydrophobic surface (low concentration of surface oxygen functional groups), may be important for driving enhanced adsorption of these hydrophobic long-chain PFAS. Superior performance of lignite AC was identified for PFBS indicating a selectivity for more difficult to adsorb short-chain compounds. The properties of the lignite AC surface, particularly the positively charged functionality, enhanced the adsorption selectivity for the more highly charged/less hydrophobic PFBS. In both cases, the transport pores also may also be advantageous.

In designing a multi-functional composition for maximum adsorption capacity and selectivity for soil and groundwater contaminants, traditional activated carbon properties, such as total pore volume, surface area, and iodine number, are important but are not fully indicative of adsorption performance capacity for petroleum hydrocarbons. Adsorption also is enhanced through additional activated carbon properties, such as surface functionalities that attract the constituents of interest and the availability of transport pores that facilitate adsorption diffusion kinetics. While an activated carbon with a higher concentration of sequestration pores (1-2× the molecular diameter of the target constituent) may have more potential adsorption sites, only a very small percentage of sequestration pores are utilized when constituent concentrations are low. This makes not only the number but also the characteristic of the sequestration pores critical in creating high energy adsorption sites suitable for sequestering trace contaminants. In addition, transport pores (up to 10× the diameter of the target constituent) may be important. These pores serve to funnel the constituent of interest to sequestration pores, to improve adsorption kinetics, and to moderate the impacts of competitive adsorption.

As will be appreciated, iodine number is defined as the milligrams of iodine adsorbed by one gram of carbon when the iodine concentration in the residual filtrate is at a concentration of 0.02 normal (i.e. 0.02N). Basically, iodine number is a measure of the iodine adsorbed in the pores and, as such, is an indication of the pore volume available in the activated carbon of interest. Iodine number is conventionally used as an indicator for contaminant sequestration capacity. Surprisingly and unexpectedly, lignite and bituminous coal outperformed coconut-based carbon in sequestering target contaminants of the present disclosure, even though coconut-based carbon may have a higher iodine number than both lignite and bituminous coal, as described in more detail with reference to Examples 1 to 13, below.

In accordance with methods of the present disclosure, activated carbon compositions are designed with specific contaminant sequestration properties, including matching activated carbon pore size to target contaminant size and surface characteristics (e.g., hydrophobicity, surface charge) to target contaminant hydrophobicity and charge. Activated carbon types have inherent characteristics, such as hydrophobicity, that can be influenced or altered by mixing different types of carbons, changing the procedure under which the carbon is activated, mixing the carbon with other additives, etc.

Table 0, below, summarizes pore size and surface characteristics ideally for sequestering typical chlorinated solvents, petroleum hydrocarbons, and PFAS.

TABLE 0
Multi-functional composition
characteristics generally ideal for contaminant types.

| | | | | Positively |
|---|---|---|---|---|
| Contaminant | Micro- | Meso- | Hydrophobic | Charged |
| Class | porosity | porosity | Surface | Surface |
| Chlorinated | X | X | X | X |
| Solvents | | | | |
| Petroleum | X | X | X | |
| Hydrocarbons | | | | |
| PFAS | X | X | X | X |

In this regard, the multi-functional composition of matter advantageously includes several functionalities that synergistically may (1) increase the probability of contact and sequestration of contaminants in a contaminated plume, (2) decrease the time required for sequestration (e.g., as a result of targeted composition functionalities that result in enhanced reaction kinetics and/or mass diffusional kinetics), and (3) advantageously reduce the total amount of material that must be applied to recover sufficient amounts of contaminants to meet end targets.

### EXAMPLES

### Example 1—Compositions of Carbons and Carbon Particle Number Density

Small particles with a D50ᵥ of 1 μm are critical to allow the activated carbon to be injected into a subsurface environment where the activated carbon particles can be pushed through the pore spaces in the ground during injection.

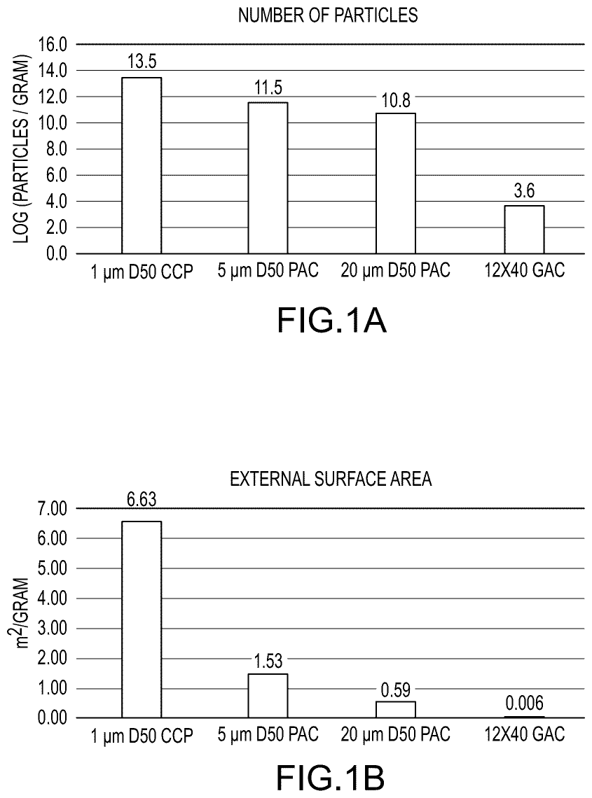

The same activated carbon was prepared at a range of particle sizes by screening and milling. The particle sizes included a standard 12×40 mesh granular activated carbon (GAC) having a D50ᵥ of 1100 μm, a standard powdered activated carbon (PAC) having a D50ᵥ of 20 μm, a colloidal carbon product (CCP) having a D50ᵥ of 5 μm, and a CCP having a D50ᵥ of 1 μm. The particle size distribution of the GAC was determined through a RO-TAP screening test. The particle size distributions of the PAC and CCPs were measured by a Micromeritics Saturn DigiSizer II employing high resolution laser light scattering. Two parameters were calculated from the measured particle size distribution. The first is the particle number density which is the number of particles per gram of activated carbon, as depicted in FIG. 1A. The second is the external surface area density which is the external surface area per gram of carbon, as depicted in FIG. 1B. These values were calculated by integrating over the incremental particle size distribution measurement and assuming a median representative spherical particle for each particle size increment.

Both the particle number density and the external surface area density increase exponentially with a decreasing particle size. In an application where contact of activated carbon with the contaminant of interest is critical to successful remediation, a smaller particle size is critically beneficial. The increased number of particles of activated carbon distributed better in the environment creating a smaller distance between activated carbon particles and subsequently less contaminate bypass. Additionally, the increased particle number density and the increased external surface area offer an increased chance that a contaminate of interest will contact the activated carbon. Finally, smaller particles increase the kinetics of adsorption. Assuming kinetics are controlled by diffusion within the pores of the activated carbon, the kinetics of adsorption scale with the diameter of the particle squared and so decreasing the particle size from a 20 μm PAC to a 1 μm CCP leads to a 400-fold increase in the time to reach equilibration. This increase in kinetics can have profound impacts on contaminate sequestration especially when the groundwater flow rate is high or when the contaminant of interest is large and/or highly hydrophobic, properties that cause adsorption to be slow.

### Example 2—Descriptions of Carbons

For further testing all base activated carbons were ground to less than a 2 μm D50ᵥ. Four samples (2, 3, 5, and 7) were used as baselines to compare to commercially available materials. The remaining samples were produced through steam activation of lignite coal (1), bituminous coal (4), and nutshell feedstocks (6). The descriptions of each of activated carbons 1 to 7 are provided below in Table 1.

TABLE 1
Activated Carbon Descriptions.

| Activated | |
|---|---|
| Carbon # | Description |
| 1 | Lignite-based activated carbon optimized for adsorption of |
| | hydrophobic contaminants |
| 2 | Water treatment industry standard activated carbon blend |
| 3 | Water treatment industry standard bituminous-based carbon |
| | blend |
| 4 | Developmental bituminous-based carbon optimized for |
| | adsorption of hydrophobic contaminates |
| 5 | Water treatment industry standard coconut-based carbon |
| 6 | Developmental nutshell-based carbon optimized for adsorption |
| | of hydrophobic contaminates |
| 7 | Water treatment industry standard sub bituminous based |
| | carbon blend |

### Example 3—Activated Carbon Ore Volume Characteristics

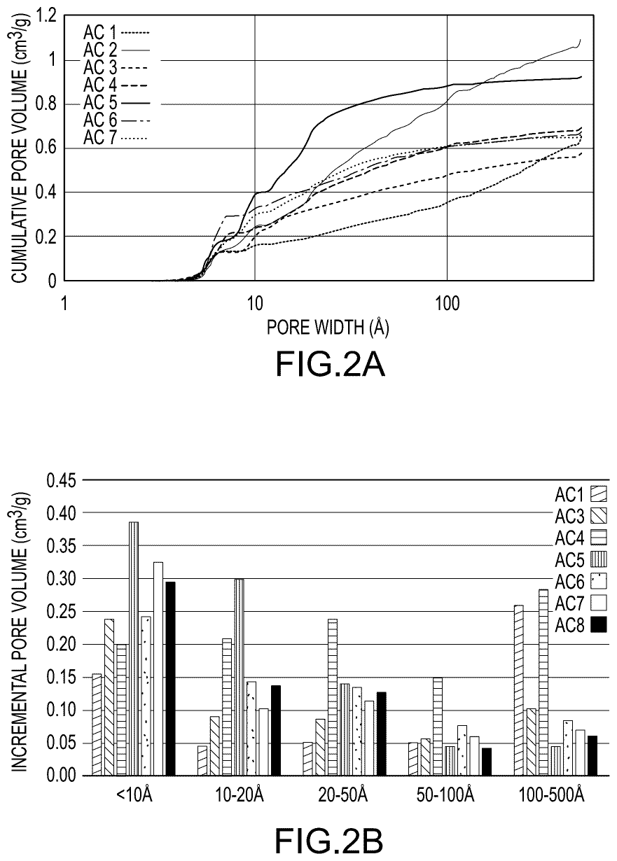

The pore volume distribution of each activated carbon 1 to 7 from Example 2 was analyzed through applying a density functional theory (DFT) model to nitrogen adsorption data generated in a Micromeritics 3Flex surface characterization analyzer. The cumulative and incremental pore volume distribution of the activated carbon products are depicted in FIGS. 2A and 2B, respectively.

Hydrophobic contaminants of interest typically have a molecular diameter in the range of about 4 to 13 angstroms (Å). Thus, desirable sequestration pore (i.e., micropore) volume of the activated carbon is in the micropore (0-20 Å) range. Also important, is transportation pore (i.e., mesopore) volume (typically in the mesopore (20-500 Å) range) to aid in the diffusion of the contaminant to the sequestration pores. The pore volumes measured for each of activates carbons 1 to 7 are provide below in Table 2.

TABLE 2
Pore volume distribution of activated carbon products.

| | micropore (<20 Å) | mesopore (20-500 Å) | micro + mesopore | |
|---|---|---|---|---|
| Activated | volume | volume | (<500 Å) volume | micropore volume/ |
| Carbon # | (cm³/gram) | (cm³/gram) | (cm³/gram) | mesopore volume |
| 1 | 0.20 | 0.36 | 0.56 | 0.55 |
| 2 | 0.41 | 0.68 | 1.09 | 0.61 |
| 3 | 0.33 | 0.25 | 0.57 | 1.33 |
| 4 | 0.39 | 0.30 | 0.69 | 1.30 |
| 5 | 0.69 | 0.23 | 0.92 | 2.95 |
| 6 | 0.43 | 0.25 | 0.67 | 1.74 |
| 7 | 0.43 | 0.23 | 0.66 | 1.87 |

### Example 4—Activated Carbon Surface Characteristics

Bulk composition of the activated carbon products 1 to 7 from Example 2 was measured by thermogravimetric analysis (TGA) via ASTM methods D2866-94 for ash, D2867-09 for moisture, and D5832-98 for volatile matter and fixed carbon content was calculated by difference. The measured volatiles, ash, and fixed carbons in dry weight percentages for each of carbons 1 to 7 are provided below in Table 3.

TABLE 3
Bulk composition of activated carbon products.

| | TGA Analysis | | |
|---|---|---|---|
| Activated | volatiles | ash | fixed carbon |
| Carbon # | (dry wt %) | (dry wt %) | (dry wt %) |
| 1 | 6.44 | 32.72 | 60.84 |
| 2 | 7.67 | 16.67 | 75.66 |
| 3 | 2.34 | 8.43 | 89.24 |
| 4 | 3.98 | 5.00 | 91.02 |
| 5 | 6.80 | 4.39 | 88.81 |
| 6 | 7.76 | 12.96 | 79.29 |
| 7 | 3.52 | 10.05 | 86.42 |

The inorganic portion of the activated carbon product accounts for as little as about 4% and up to greater than about 30% of the total mass. The ash component can play a critical role in influencing adsorption of contaminants by reacting with the contaminants of interest through electrostatic interactions, dipole-dipole interactions, Van der Waals interactions, H-bonding interactions, redox reactions, and/or ion exchange reactions. As such, the total concentration and composition of the ash fraction is important in driving chemisorption mechanism. The composition of major (>1000 mg/kg) and minor (100-1,000 mg/kg) heavy elements was measured by particle-induced X-ray emission analysis (PIXE). In addition to the inorganic fraction, the hydrogen and nitrogen content of the activated carbons was measured with method ASTM D5373-04 using a Thermoscientific Flashsmart CHN instrument. The minor and major heavy elemental composition and hydrogen and nitrogen compositions of activated carbon samples 1 to 7 are provided below in Tables 4 and 5.

Particularly important in driving chemisorption mechanism may be the nitrogen content of the activated carbon. Nitrogen can be positively charged, and thus beneficial for removing negatively charged or negatively polar species, such as chlorinated solvents, per and polyfluoroalkyl substances, polychlorinated biphenyls, and/or oxyanions. Also important for imbedding positively charged or positively polar functionality and/or anion exchange sites into the activated carbon surface may be calcium, iron, aluminum, magnesium, manganese, titanium, strontium, sodium, and potassium.

TABLE 4
Minor and Major heavy elemental composition of activated
carbon samples evaluated with PIXE analysis.

| | Activated Carbon # | | | | | | |
|---|---|---|---|---|---|---|---|
| | | 1 | 3 | 4 | 5 | 6 | 7 |
| PIXE analysis: Major | Silicon | 21,710 | 10,840 | 4,980 | 770 | 1,320 | 14,370 |
| and Minor Constituent | Calcium | 15,830 | 1,140 | 1,800 | 1,250 | 22,380 | 980 |
| Composition in ppm | Iron | 15,000 | 3,520 | 2,680 | 229 | 170 | 7,890 |
| (mg/kg) | Aluminium | 12,050 | 8,810 | 4,580 | 206 | 670 | 12,190 |
| | Magnesium | 9,230 | 528 | 857 | 588 | 4,130 | 1,090 |
| | Sulphur | 6,890 | 4,250 | 3,500 | 320 | 287 | 4,090 |
| | Manganese | 1,060 | 14 | 41 | 6 | 116 | 170 |
| | Titanium | 1,030 | 429 | 1,250 | 17 | <8 | 1,470 |
| | Potassium | 780 | 972 | 535 | 5,660 | 14,290 | 110 |
| | Strontium | 400 | 138 | 103 | 7 | 207 | 92 |
| | Sodium | <399 | 518 | 672 | 989 | 975 | <219 |
| | Phosporous | <24 | <16 | 216 | 261 | 1,000 | <21 |
| CHN analysis: ppm | Hydrogen | 4700 | 2800 | 5200 | 3300 | 5700 | 2100 |
| (mg/kg) | Nitrogen | 4400 | 3500 | 4400 | 1100 | 2900 | 2600 |

TABLE 5
Hydrogen, carbon, and nitrogen content of the activated carbons by
CHN analysis ASTM method D5373-04.

| | | | | wt. hydrogen/ | wt. nitrogen/ |
|---|---|---|---|---|---|
| Activated | carbon | hydrogen | nitrogen | wt. | wt. |
| Carbon # | wt. % | wt. % | wt. % | carbon*1000 | carbon*1000 |
| 1 | 68.34 | 0.47 | 0.44 | 6.88 | 6.44 |
| 3 | 89.13 | 0.28 | 0.35 | 3.14 | 8.93 |
| 4 | 84.52 | 0.52 | 0.44 | 6.15 | 5.21 |
| 5 | 91.48 | 0.33 | 0.11 | 3.61 | 1.20 |
| 6 | 81.14 | 0.57 | 0.29 | 7.02 | 3.57 |
| 7 | 86.72 | 0.21 | 0.26 | 2.42 | 3.00 |

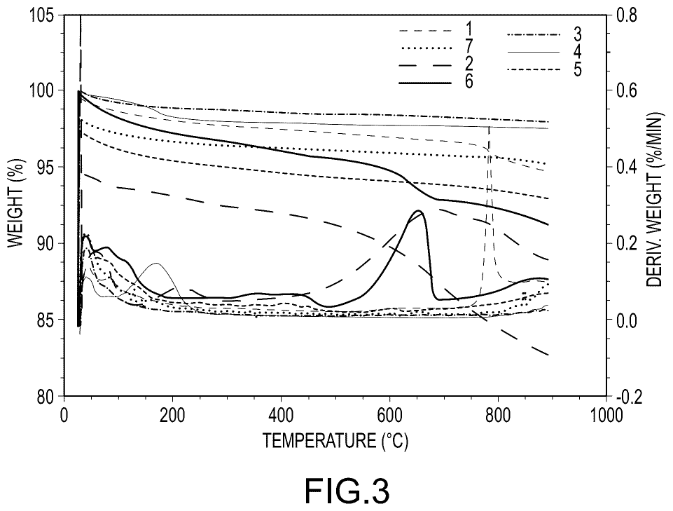

Also important in driving chemisorption reactions are surface oxygen functional groups. The surface oxygen functional group content was analyzed utilizing a TA Q600 SDT interfaced using a heated capillary transfer pan to a Pfeiffer Thermostar mass spectrometer. Under an argon environment, approximately 20 mg of sample was held at room temperature for about 30 minutes then heated to about 900° C. at about 10° C./minute. Then, temperature dependent weight loss was quantified by Thermogravimetric analysis (TGA) and off-gas was qualified by mass spectroscopy (Western Kentucky University Thermal Analysis Laboratory). The results of the TGA of the activated carbons are presented in FIG. 3.

The type of surface oxygen functionality can be inferred from the decomposition temperature and from the form of gas that evolved (CO₂ or CO). Surface oxygen functionality can impact adsorption in multiple ways. First, the surface oxygen functional groups create a more polar or more hydrophilic surface which is undesirable for hydrophobic contaminants, such as per and polyfluoroalkyl substances, hydrocarbons, Polychlorinated biphenyls, and/or chlorinated solvents. Second, the functional groups can cause steric hinderance impacts by blocking access to adsorption sites. Finally, they can impact the activated carbon's surface charge and charge distribution. For example, most oxygen functional groups are acidic leading to a more negative surface charge. For negatively charged or negatively polar contaminants, a more positive surface is desirable. The charge of the activated carbon surface may also be important for impacting the mobility of the activated carbon in the subsurface as a positively charged surface would be attracted to the soil (which generally holds a net negative charge) whereas a negatively charged activated carbon surface would be repelled. An example of surface charge distribution being impacted by surface oxygen functional groups is in the resonance of a carboxylic acid functional group which withdraws election density from the adjacent graphene planes of the activated carbon while the resonance of a phenol group donates electron density to the adjacent activated carbon graphene plane.

Of particular importance are surface oxygen functional groups that decompose in the temperature range of about 400-750° C. which primarily constitute carboxylic acid functional groups. Below this temperature range, most of the weight loss can be contributed to physiosorbed and chemisorbed water. Above this temperature range, most of the weight loss can be contributed to more stable functional groups such as carbonyl and ether groups as well as mineral carbonates. The weight loss of each carbon sample at various temperature ranges is provided below in Table 6.

TABLE 6
Surface oxygen functional groups measured with TGA.

| Activated | TGA wt loss | TGA wt loss |
|---|---|---|
| Carbon # | (400-750° C.) | (750-900° C.) |
| 1 | 0.95 | 1.81 |
| 2 | 3.34 | 0.95 |
| 3 | 0.38 | 0.25 |
| 4 | 0.19 | 0.23 |
| 5 | 0.99 | 0.72 |
| 6 | 3.50 | 0.76 |
| 7 | 0.52 | 0.56 |

The net charge of the activated carbon surface can be approximated with a slurry pH test. Three grams of activated carbon are added to 30 mL of deionized water and the solution is allowed to stir with a magnetic stir bar for about 10 minutes. After 10 minutes, the pH of the slurry is measured. The slurry pH gives you an approximation of the activated carbon surface's point of zero charge or the point where the sum of surface's positively charged sites is equal to the sum of the surface's negatively charged sites. At a pH greater than the point of zero charge the carbon surface has a net negative charge whereas at a pH less than the point of zero charge, the activated carbon surface will have a net positive charge. For adsorbing negatively charge or negatively polar contaminates, a high point of zero charge is desirable such that under most environmental conditions, the activated carbon surface has more positively charged sites than negatively charged sites. The slurry pH of each of the activated carbon samples is provided in Table 7.

TABLE 7
Slurry pH of activated carbon products.

| Activated | |
|---|---|
| Carbon # | slurry pH |
| 1 | 12.1 |
| 2 | 7.3 |
| 3 | 10.3 |
| 4 | 10.2 |
| 5 | 9.7 |
| 6 | 12.5 |
| 7 | 10.0 |

### Example 5: Chlorinated Solvents Adsorption Isotherms

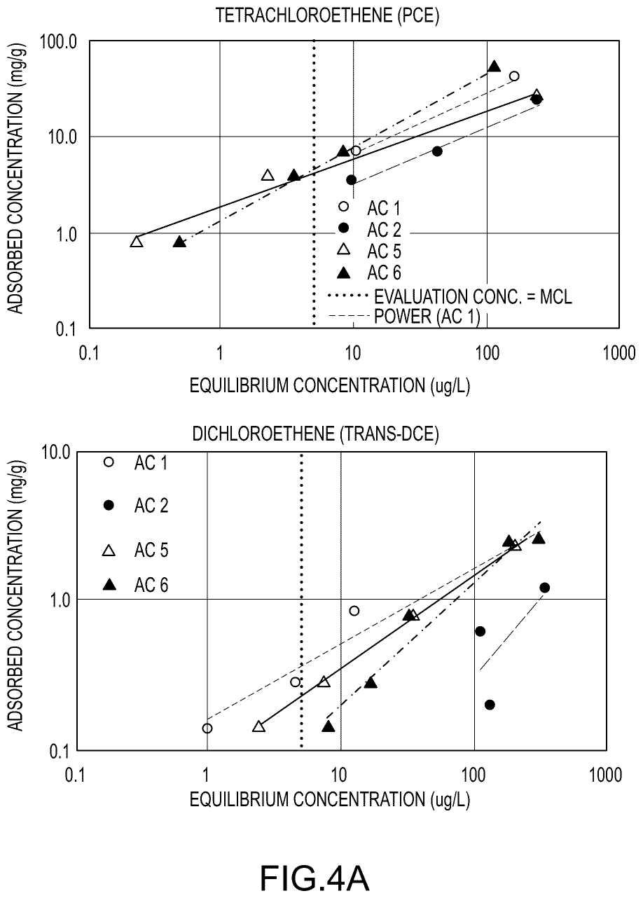

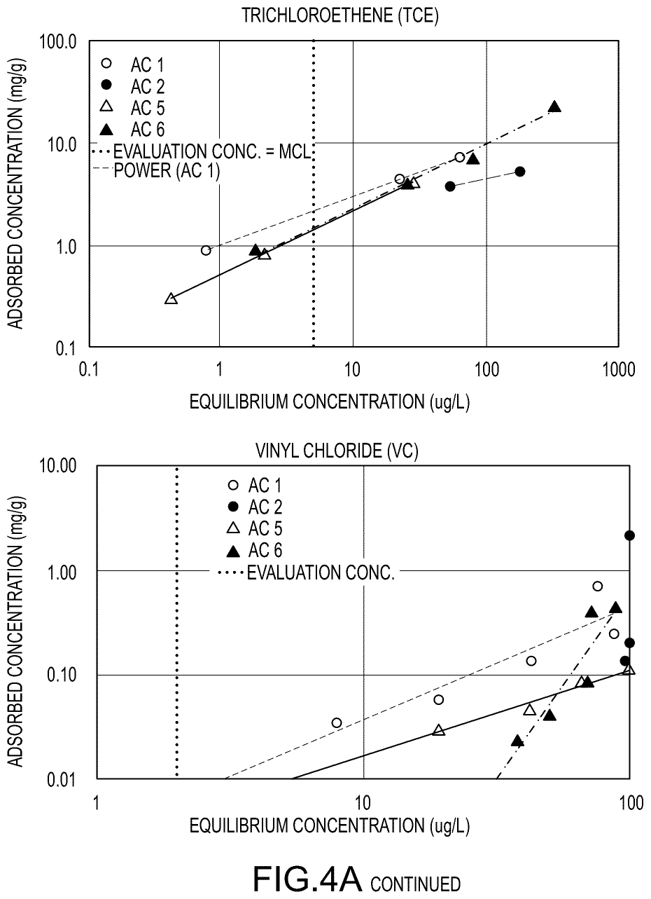

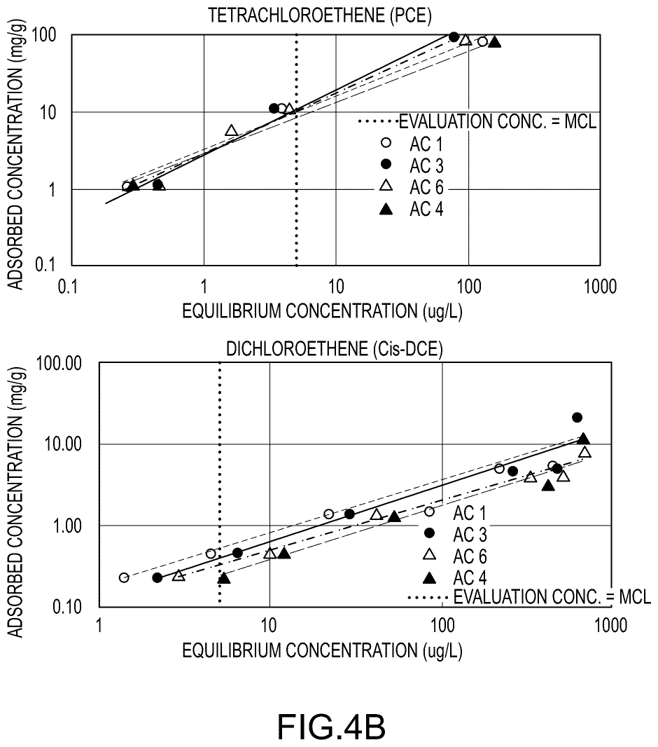

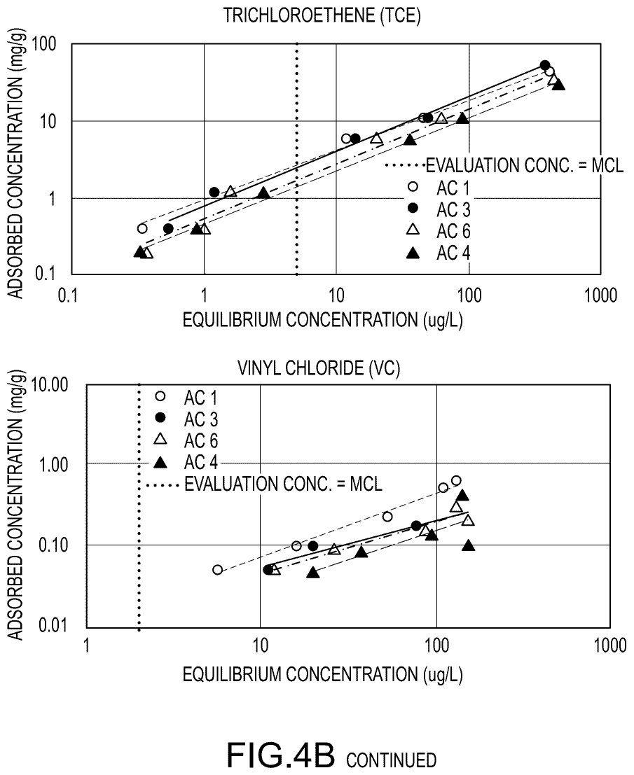

Two rounds of Jar tests were completed to evaluate the adsorption of chlorinated solvents to a range of activated carbons. The results of round 1 are provided in FIG. 4A and the results of round 2 are provided in FIG. 4B. The tests were carried out using synthetic groundwater in about 250 mL amber jars with PTFE-lined septa caps. The synthetic groundwater consisted of deionized water with about 350 mg/L (ppm) total dissolved solids as instant ocean sea salt and about 100 mg/L of sodium azide to restrict biological growth. All jars were dosed with about 1 mg/L (ppm) of each tetrachloroethene (PCE), trichloroethene (TCE), dichloroethane (trans t-DCE or cis c-DCE), and vinyl chloride (VC). Six dosages of each carbon sample were used. The jars were allowed to mix on a shaker table for two weeks, then samples were removed from the mechanical shaker and filtered with a less than about 0.45 μm syringe filter. Water samples were analyzed via high resolution GC-MS by method 8260B at Test America Laboratories. Method blanks, laboratory control samples, and surrogate compounds were used.

To compare carbons, performance factors were calculated by first establishing a Freundlich isotherm (power line of best fit to correlate the adsorbed constituent concentration on the activated carbon to the concentration still in the water phase at equilibrium). An equilibrium concentration, typically a relevant treatment goal such as the Maximum Contaminant Level (MCL), was chosen. Then, the performance factor was calculated as the ratio of the adsorbed concentration for the baseline activated carbon (AC 1) to the carbon of interest at the chosen evaluation equilibrium concentration. The performance factor has units of weight of carbon of interest needed per weight of AC 1 needed to achieve the same target contaminant equilibrium concentration. Superior performance of AC 1 was observed especially for less hydrophobic/less chlorinated compounds where chemisorption mechanism becomes more important for driving the extent of adsorption. The results are provided below in Table 8.

TABLE 8
Performance factors calculated from chlorinated solvent adsorption data.

| | | | PCE | TCE | t-DCE | c-DCE | VC |
|---|---|---|---|---|---|---|---|
| | | | gAC/gAC1 | gAC/gAC1 | gAC/gAC1 | gAC/gAC1 | gAC/gAC1 |
| | | | needed at | needed at | needed at | needed at | needed at |
| | | | 5 ppb | 5 ppb | 5 ppb | 5 ppb | 33 ppb |
| | | | equilibrium | equilibrium | equilibrium | equilibrium | equilibrium |
| Constituent | | | PCE | TCE | t-DCE | c-DCE | VC |
| Performance | Round 1 | AC 1 | 1.00 | 1.00 | 1.00 | | 1.00 |
| Factors | | AC 2 | 1.99 | 2.49 | 4.06 | | N/A |
| with respect | | AC 5 | 1.07 | 1.50 | 1.58 | | 3.08 |
| to AC 1 | | AC 6 | 0.95 | 1.40 | 3.05 | | 11.66 |
| | Round 2 | AC 1 | 1.00 | 1.00 | | 1.00 | 1.00 |
| | | AC 3 | 0.94 | 1.09 | | 1.29 | 1.74 |
| | | AC 6 | 0.98 | 1.62 | | 1.55 | 1.92 |
| | | AC 4 | 1.18 | 1.91 | | 2.13 | 2.63 |

### Example 6: Hydrocarbons Adsorption Isotherms

Jar tests were completed to evaluate the adsorption of a range of hydrocarbon constituents to a range of activated carbon products. Tests were carried out using synthetic groundwater in about 250 mL amber jars with PTFE-lined septa caps. The synthetic groundwater consisted of deionized water with about 350 mg/L (ppm) total dissolved solids as instant ocean sea salt and about 100 mg/L of sodium azide to restrict biological growth. All jars were dosed with about 1 mg/L (ppm) of each benzene, toluene, ethylbenzene, para-xylene, and methyl tert-butyl ether (MTBE). Six dosages of each activated carbon sample were used. The jars were allowed to mix on a shaker table for two weeks, then samples were removed from the mechanical shaker and filtered with a less than about′ 0.45 μm syringe filter. Water samples were analyzed via high resolution GC-MS by method 8260B at Test America Laboratories. Method blanks, laboratory control samples, and surrogate compounds were used.

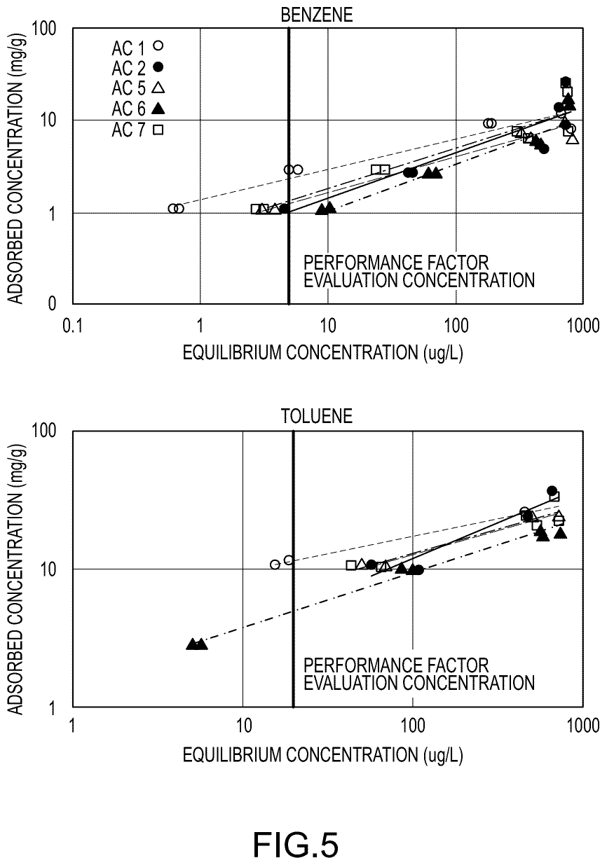

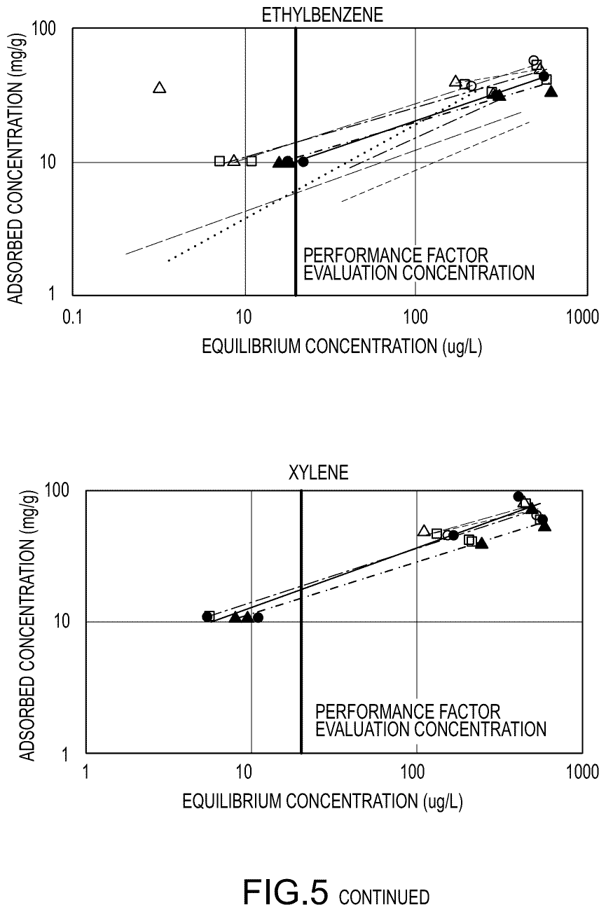

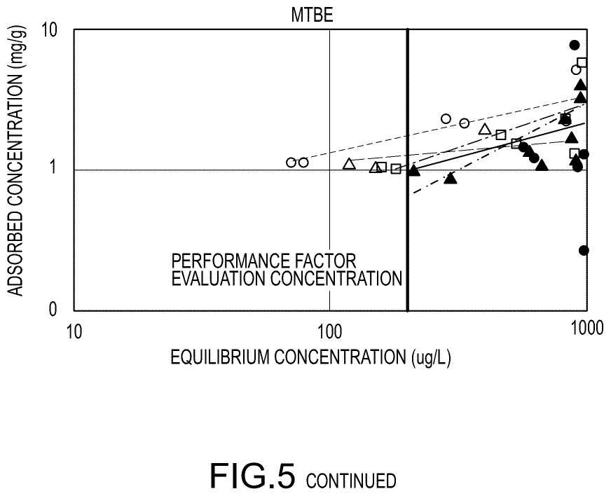

To compare carbons, performance factors were calculated by first establishing a Freundlich isotherm (power line of best fit to correlate the solid phase concentration of adsorbed constituent to the concentration still in the water phase at equilibrium). An equilibrium concentration, typically a relevant treatment goal, was chosen. Then, the performance factor was calculated as the ratio of the adsorbed concentration for the baseline activated carbon (AC 1) to the carbon of interest at the chosen evaluation equilibrium concentration. The performance factor has units of weight of carbon of interest needed per weight of AC 1 needed to achieve the same target contaminant equilibrium concentration. The results of Example 6 are provided in FIG. 5 and Table 9.

TABLE 9
Performance factors calculated from hydrocarbon adsorption data.

| | | Benzene | Toluene | Ethylbenzene | Xylene | MTBE |
|---|---|---|---|---|---|---|
| | | gAC/gAC1 | gAC/gAC1 | gAC/gAC1 | gAC/gAC1 | gAC/gAC1 |
| | | needed at | needed at | needed at | needed at | needed at |
| | | 5 ppb | 20 ppb | 20 ppb | 20 ppb | 200 ppb |
| Constituent | | equilibrium | equilibrium | equilibrium | equilibrium | equilibrium |
| Performance Factors | AC 1 | 1.00 | 1.00 | 1.00 | 1.00 | 1.00 |
| with respect to AC 1 | AC 2 | 2.36 | 2.34 | 2.44 | 1.07 | 1.78 |
| | AC 5 | 1.66 | 1.53 | 1.78 | 1.14 | 1.38 |
| | AC 6 | 3.31 | 2.33 | 2.27 | 1.80 | 2.71 |
| | AC 7 | 1.82 | 1.51 | 1.73 | 1.45 | 1.59 |

Superior performance of AC 1 was observed especially for less hydrophobic compounds where chemisorption mechanism becomes more important for driving the extent of adsorption. This can be seen from the shallow slope of the Freundlich isotherm plot in FIG. 5 which indicates a more heterogeneous distribution of adsorption sites. A higher capacity at low equilibrium concentrations is indicative of more high energy adsorption sites.

### Example 7: Adsorption of Per and Polyfluoroalkyl Substances (PFAS)

Jar tests were completed to evaluate the single-solute adsorption of three PFAS compounds: perfluorooctanoic acid (PFOA), perfluorooctane sulfonic acid (PFOS) and perfluorobutane sulfonic acid (PFBS) to a range of activated carbons. Tests were carried out using synthetic groundwater in about 10 mL polypropylene bottles. The synthetic groundwater consisted of deionized water with about 370 mg/L (ppm) total dissolved solids. Bottles were dosed with about 10 mg activated carbon and about 7 initial PFAS concentrations were used. The jars were allowed to mix on a shaker table for 3 days. Then, samples were removed from the mechanical shaker, centrifuged, and filtered with a less than 0.2 μm syringe filter. Water samples were analyzed via high resolution LC-MS/MS.

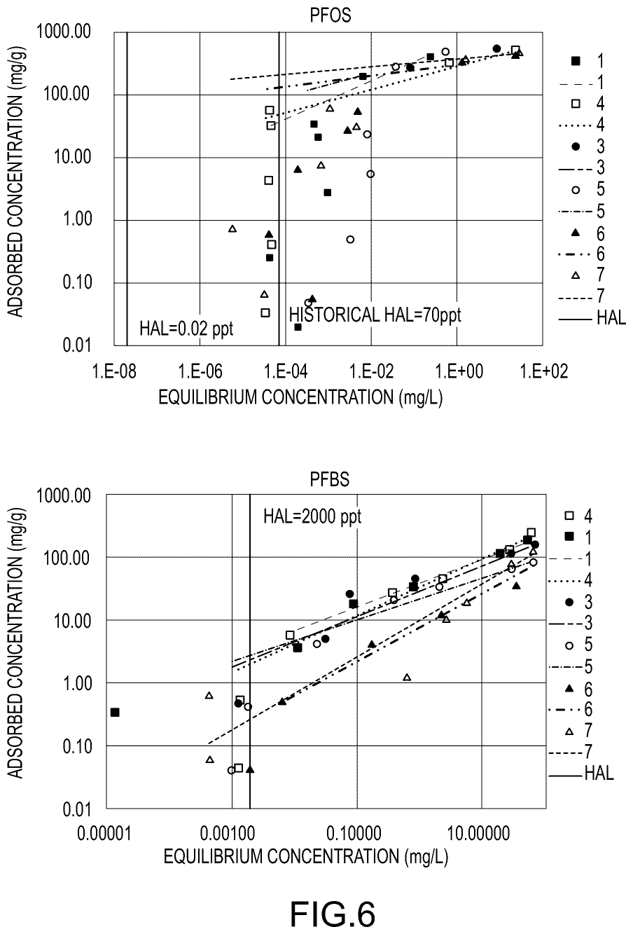

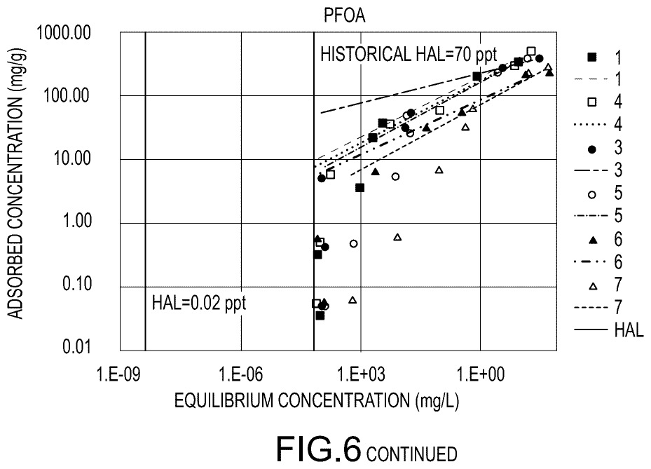

The data, provided in FIG. 6, reveals that PFAS adsorption and carbon ranking is highly dependent on the equilibrium concentration. For example, at high equilibrium concentrations, the highly microporous carbon 5 has PFOS and PFOA adsorbed concentrations that are similar to the other top performing carbons. Conversely, at equilibrium concentrations close to the EPA's health advisory limits (HALs), carbon 5 has adsorbed concentrations that is multiple orders of magnitude lower than the top performing carbons. These results indicated that while the highly microporous carbon 5 has many adsorption sites, these adsorption sites are lower energy and require a larger concentration driving force to be filled.

### Example 8: Adsorption of Polychlorinated Biphenyls (PCBs)

Jar tests were completed to evaluate the adsorption of a range of Polychlorinated Biphenyl (PCB) congeners to a range of activated carbon products. Tests were carried out in synthetic groundwater in 250 mL amber bottles with Phenolic aluminum lined caps to minimize the volatile loss of PCBs. Synthetic groundwater consisted of deionized water with about 350 mg/L (ppm) total dissolved solids as instant ocean sea salt and about 100 mg/L of sodium azide to restrict biological growth. Four levels of PCB concentrations were used for each carbon. A passive sampler (PDMS fiber) was used to measure the PCB concentration in the water. The jars were allowed to mix on a shaker table for three weeks, then PDMS fiber was removed from the jar, extracted, and analyzed via high resolution GC-MS by method 1668C using isotope dilution calculation. Method blanks, laboratory control samples, and surrogate compounds were used.

TABLE 10
Performance factors calculated from PCB adsorption data.

| | | PCB-14 | PCB-36 | PCB-78 | PCB-104 | PCB-121 | PCB-142 | PCB-155 |
|---|---|---|---|---|---|---|---|---|
| Constituent | | gAC/gAC1 | gAC/gAC1 | gAC/gAC1 | gAC/gAC1 | gAC/gAC1 | gAC/gAC1 | gAC/gAC1 |
| Performance Factors | AC 1 | 1.00 | 1.00 | 1.00 | 1.00 | 1.00 | 1.00 | 1.00 |
| with respect to AC 1 | AC 2 | 2.01 | 2.13 | 2.21 | 1.02 | 1.29 | 0.95 | 0.99 |

Superior performance of AC 1 was observed, as demonstrated in Table1 10, especially for less hydrophobic and/or less chlorinated congeners where chemisorption mechanism becomes more important for driving the extent of adsorption.

### Example 9: Activated Carbon Modified with a Positively-Charged Nitrogen-Functionalized Organic Compound

A positively-charged nitrogen-functionalized organic compound is useful for providing a positively charged site to interact with negatively charged or negatively polar contaminants such as per and polyfluoroalkyl substances, chlorinated solvents, polychlorinated biphenyls and/or oxyanions. A range of nitrogen-functionalized organic compounds were sprayed onto AC 1 in a ReadCo mixer to add positive functionality to the activated carbon for adsorption of positively charged and positively polar pollutants. The activated carbon samples were then subjected to an Organics Leaching Tests where about 5 grams of the carbon was added to about 500 mL of deionized water and allowed to stir at room temperature for a week. The water was then filtered out with a 0.45 μm vacuum filter. The amount of the nitrogen-functionalized organic compound remaining on the carbon surface was measured with a TGA analysis under nitrogen atmosphere. The weight percent leached was calculated as the difference in the mass of nitrogen-functionalized organic compound evolved under the TGA analysis before and after the organics leaching test. The results are provided below in Table 11.

TABLE 11
Results of organics leach test for nitrogen-
factionalized activated carbons.

| Description | wt % leached |
|---|---|
| AC 1 | 0% |
| AC 1 + 20% BTC 818 | 58% |
| AC 1 + 20% Ammonyx cetac | 54% |
| AC 1 + 20% Stepanquat 50 NF | 55% |
| AC 1 + 20% BTC 888 | 52% |
| AC 1 + 10% Stepanquat 50 NF | 16% |

It is desirable to have a small amount of the nitrogen-functionalized compound leach off so that it can migrate through the soil a moderate distance, extending the sphere of influence of the nitrogen functionalization. The fraction of the organic compound that disassociates from the activated carbon particle will adsorb onto the subsurface soil matrix effectively increasing coverage of the combined amendment.

Without being bound by theory, the nitrogen-functionalized organic compound may also be beneficial in acting as a multi-functional rheology additive during manufacturing and in aiding in the formation of a stable activated carbon dispersion.

### Example 10: Production of Activated Carbon Slurry with Wet Ball Mill

The activated carbons were milled to less than 1 μm using a Netzsch LabStar wet ball mill. For this process, a softer activated carbon is desirable in order to decrease the energy required to reach the target particle size. Multi-functional rheology additives were used to act as lubricants, to reduce particle agglomeration, and to modify the viscosity of the slurry. For this purpose, carboxymethyl cellulose (CMC) and a sodium lignosulfonate (Borregaard D-949L) were used. The addition of the multi-functional rheology additive made it possible to increase the activated carbon percent in the slurry without causing the viscosity to become prohibitively high. The additives also improved the milling speed by about 50-60%, and significantly increased the stability of the activated carbon dispersion. The results are provided in Tables 12 and 13.

TABLE 12
Results of milling tests using multi-functional rheology additives.

| | Milling | | | | Dispersion |
|---|---|---|---|---|---|
| | milling speed | | PSD | | time to start |
| | min/lb AC | Viscosity | D50 | D90 | settling at |
| Description | processed | cp at 3 rpm | (μm) | (μm) | 0.5 _{wt} % AC, min |
| 7 wt % AC 1 | 115 | 2260 | 0.72 | 7.2 | 2 min |
| 13 wt % AC 1 + 2.1 wt % CMC | 60 | 2020 | 0.58 | 1.2 | 2+ days |
| 13 wt % AC 1 + 4.2 wt % CMC | 45 | 8530 | 0.68 | 1.6 | 2+ days |
| 13 wt % AC 1 + 3.2 wt % Borregaard D-949L | 45 | 5030 | 0.51 | 1.1 | 1 hr |

TABLE 13
Ball Pan Hardness of selected activated carbons as measured
by ASTM method D3802.

| | Ball Pan Hardness of activated carbon |
|---|---|
| Carbon # | feedstock screened to 12 × 40 mesh |
| 1 | 55 |
| 6 | 66 |
| 4 | 94 |
| 3 | 95 |

### Example 11: Activated Carbon for Adsorbing Petroleum Hydrocarbons

The goal of this work was to evaluate the capacity and selectivity of different base ACs for adsorbing common BTEX compounds (i.e., benzene, toluene, ethylbenzene, xylenes) and to garner a greater understanding of driving adsorption mechanisms. A breakdown of common hydrocarbons (e.g., BTEX) properties and associated AC features is shown in Table 14, below.

TABLE 14
Typical BTEX properties and associated AC features.

| | | | Sequestration | Transport | |
|---|---|---|---|---|---|
| | | | Pore Width | Pore Width | |
| | | Molecular | (1-2× molecular | (up to 10× molecular | Hydrophobicity |
| | | Diameter | diameter) | diameter) | (log K_{ow}) |
| Benzene | 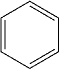 | ~5.8Å | 5.8-12Å | 12-58Å | hydrophobic (2.1) |
| Toluene | 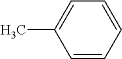 | ~6.1Å | 6.1-12Å | 12-61Å | hydrophobic (2.7) |
| Ethylbenzene | 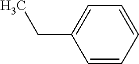 | ~6.4Å | 64-13Å | 13-64Å | hydrophobic (3.2) |
| Xylenes | 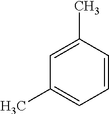 | ~6.4Å | 6.4-13Å | 13-64Å | hydrophobic (3.2) |

Sequestration and transport pores are defined to be about 1-2 times and up to about 10 times the constituent's molecular diameter, respectively. The hydrophobicity of the constituent is approximated by the octanol-water partitioning coefficient (log K_{ow}), with the lower value of the coefficient representing lower hydrophobicity.

The adsorption capacity of three ACs manufactured from different base raw materials were evaluated using batch isotherm testing: a coconut-based AC, a bituminous-based AC, and a lignite-based AC. The ACs were sized to a D50_{V} particle size of 1-2 μm then subjected to a standard laboratory isotherm test. AC properties were also measured as exhibited in Table 15, below. Iodine number and nitrogen porosimetry pore size and volume distribution give an indication of available adsorption sites. The ASTM pH, normalized cationic functionality, and normalized surface oxygen functionality represent the receptivity of the AC surface to attract and sequester the constituents of interest. For a less hydrophobic/more polar molecule, the surface charge may be particularly important for attracting negatively polar species. An AC surface with less oxygen functional groups may be more hydrophobic attracting hydrophobic constituents.

TABLE 15
Properties of the activated carbons tested.

| AC Property | Lignite AC | Coconut AC | Bituminous AC |
|---|---|---|---|
| Iodine Number (mg/g) | 500 | 1300 | 1000 |
| ASTM pH | 12.1 | 9.7 | 10.3 |
| Total Pore Volume < 500 Å | Medium | High | Medium |
| (cm³/gram) | | | |
| Micropores for Sequestration | Low | High | Medium |
| (cm³/gram) | | | |
| Small Mesopores for Transport | High | Low | Medium |
| (cm³/gram) | | | |
| Cationic Functionality | High | Low | Medium |
| Surface Oxygen Functionality | High | Medium | Low |

BTEX adsorption tests were carried out using synthetic groundwater in 250 mL amber jars with PTFE-lined septa caps. The synthetic groundwater consisted of deionized water with about 350 mg/L (ppm) total dissolved solids as instant ocean sea salt and about 100 mg/L of sodium azide to restrict biological growth. All jars were dosed with about 1 mg/L (ppm) of each benzene, toluene, ethylbenzene, and para-xylene. Six dosages of each carbon were used. The jars were allowed to mix on a shaker table for two weeks to allow for equilibrium to be reached, then samples were removed from the mechanical shaker and filtered with a less than 0.45 μm syringe filter. Water samples were analyzed via high resolution GC-MS by method 8260B. Method blanks, laboratory control samples, and surrogate compounds were used.

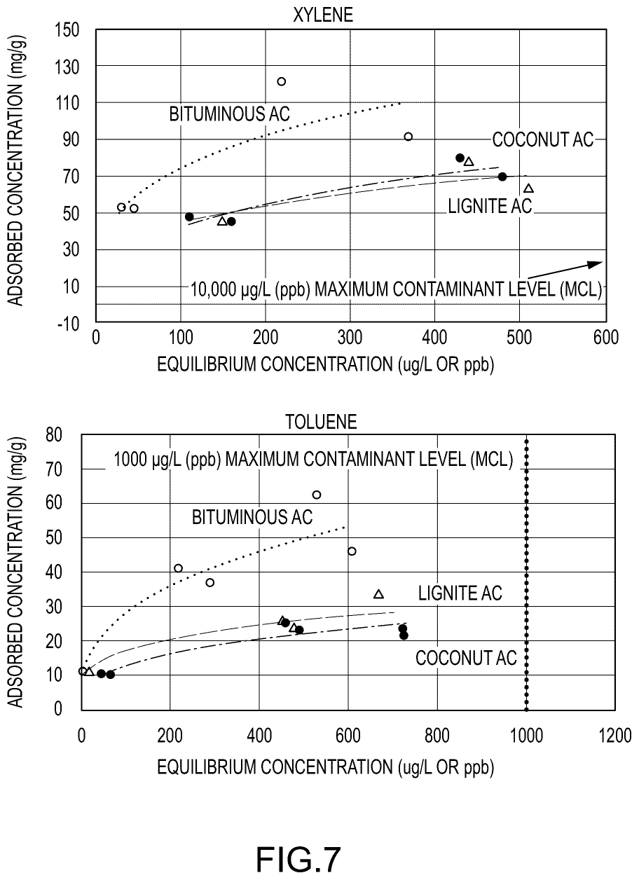

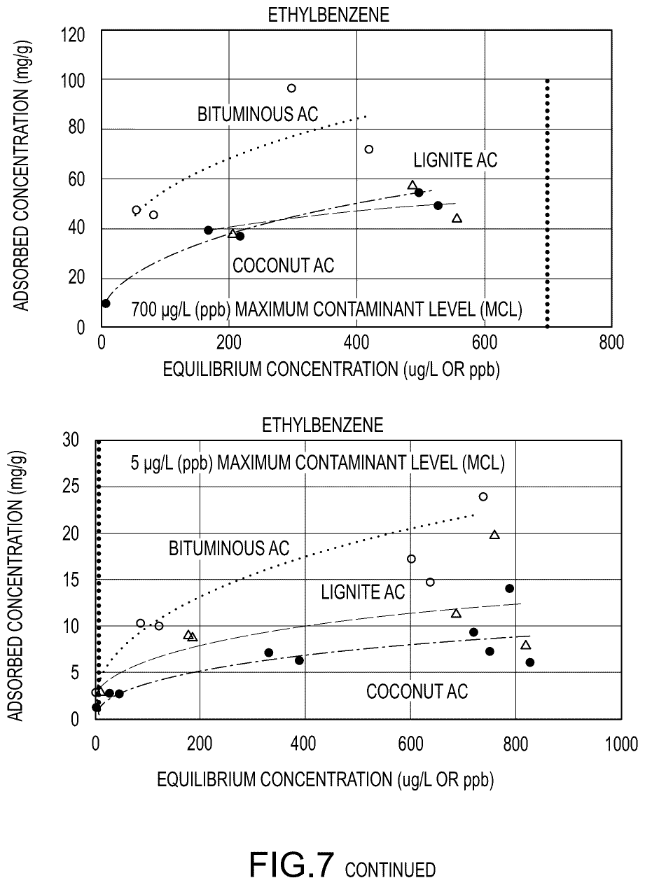

FIG. 7 depicts batch adsorption testing results as isotherm plots. A Freundlich isotherm model was established for each contaminate/AC pair (power line of best fit to correlate the adsorbed constituent concentration on the AC to the concentration still in the water phase at equilibrium).

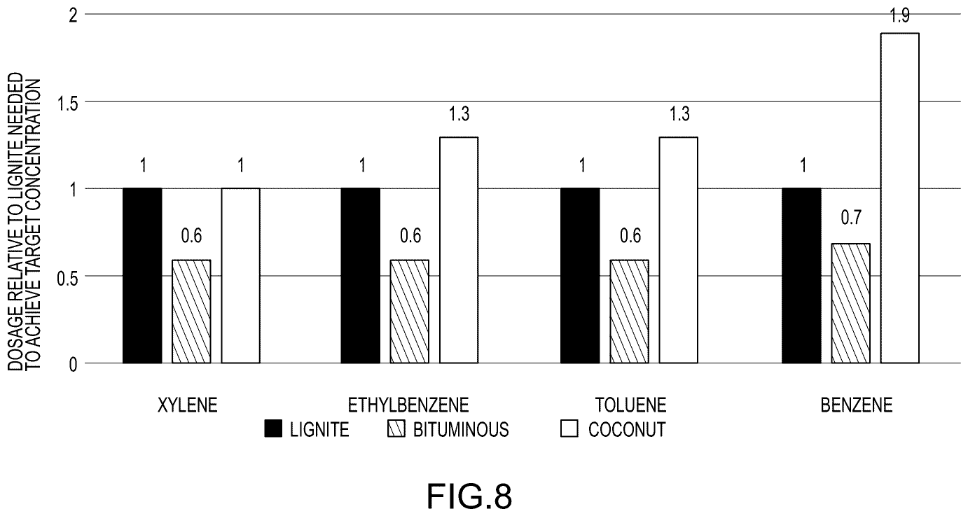

Adsorption performance is highly dependent on the different properties inherent to AC type as well as the constituent of interest and the concentration of the constituent of interest. To quantify performance comparison between AC types, a reference equilibrium concentration is chosen. For benzene, the reference equilibrium concentration was chosen to be the Maximum Contaminant Level (MCL). For toluene, ethylbenzene, and xylene, all the analytical data was well below their associated MCLs, so an equilibrium concentration of 100 ppb was chosen as the reference. Then, a performance factor was calculated as the ratio of the adsorbed concentration for the lignite AC carbon to the AC of interest at the reference equilibrium concentration. The performance factor for the reference AC (lignite) is 1.0. The units of the performance factor are the weight of the AC of interest per weight of the lignite AC needed to achieve the same target contaminant equilibrium concentration. For example, as provided in Table 16 and FIG. 8, a performance factor of 1.9 for benzene indicates that the dosage of coconut AC will need to be 1.9 times higher than the dosage of lignite to achieve the same equilibrium concentration. Conversely, a performance factor of 0.7 for benzene indicates that the dosage of bituminous AC can be 30% lower than the dosage of lignite to achieve the same final concentration.

TABLE 16
Performance factor or relative dosage compared to lignite carbon
needed to reach target equilibrium concentration.

| | | Target | Lignite dose | Bituminous | Coconut |
|---|---|---|---|---|---|
| | Initial | Equilibrium | relative to | dose relative | dose relative |
| Constituent | Concentration | Concentration | lignite | to lignite | to lignite |
| Xylene | 1000 μg/L | 5 μg/L (MCL) | 1.0 X | 0.6 X | 1.0 X |
| Ethylbenzene | 1000 μg/L | 5 μg/L (MCL) | 1.0 X | 0.6 X | 1.3 X |
| Toluene | 1000 μg/L | 7 μg/L (MCL) | 1.0 X | 0.6 X | 1.3 X |
| Benzene | 1000 μg/L | 2 μg/L (MCL) | 1.0 X | 0.7 X | 1.9 X |

Generally, the performance ranking from most effective or lowest dosage rate to the least effective or highest dosage is as follows bituminous>lignite>coconut. The trend does not track what would be observed if adsorption was controlled by sequestration or total pore volume, or by surface hydrophobicity alone. Instead, adsorption performance is controlled by a combination of factors including both pore volume distribution and surface chemistry.

In designing ACs for maximum adsorption capacity and selectivity for BTEXs, traditional AC properties, such as total pore volume, surface area, and iodine number, are important but are not fully indicative of adsorption performance capacity for petroleum hydrocarbons. Adsorption also is enhanced through additional AC properties, such as surface functionalities that attract the constituents of interest and the availability of transport pores that facilitate adsorption diffusion kinetics. While an AC with a higher concentration of sequestration pores (1-2× the molecular diameter of the target constituent) may have more potential adsorption sites, only a very small percentage of sequestration pores are utilized when constituent concentrations are low. This makes not only the number but also the characteristic of the sequestration pores critical in creating high energy adsorption sites suitable for sequestering trace contaminants.

In addition, transport pores (up to 10× the diameter of the target constituent) may be important. These pores serve to funnel the constituent of interest to sequestration pores, to improve adsorption kinetics, and to moderate the impacts of competitive adsorption.

Superior performance of bituminous AC was identified for BTEX compounds. The properties of this bituminous AC, particularly the highly hydrophobic surface character and the multi-modal pore volume distribution, enhanced the adsorption capacity for BTEX compounds.

Results from these lab batch tests give quantitative trends in adsorption performance of BTEX compounds to the ACs tested. Specific adsorption capacities at a remediation site will vary based on site-specific conditions such as background water quality and relative concentrations of competing contaminants. None-the-less, these results highlight the importance of tuning AC porosity and surface characteristics in controlling adsorption of BTEX compounds. AC functionalities responsible for controlling the BTEX capture mechanisms can be engineered onto a range of AC base materials.

### Example 12: Activated Carbon for Adsorbing Chlorinated Solvents

The goal of this work was to evaluate the capacity and selectivity of different base ACs for adsorbing common chlorinated volatile organic compounds (CVOCs) (e.g., tetrachloroethylene (PCE), trichloroethylene (TCE), dichloroethylene (DCE), and vinyl chloride (VC)) and to garner a greater understanding of driving mechanisms for adsorption of CVOCs. A breakdown of common CVOC properties and associated AC features are shown in Table 17.

TABLE 17
Typical CVOC properties and associated AC features.

| | | | | Transport | |
|---|---|---|---|---|---|
| | | | Sequestration | Pore Width | |
| | | Molecular | Pore Width | (up to 10× molecular | Hydrophobicity |
| | | Diameter | (1-2× molecular diameter) | diameter) | (log K_{ow}) |
| PCE tetrachloroethylene | 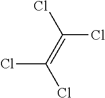 | ~58Å | 58-12Å | 12-58Å | hydrophobic (3.4) |
| TCE trichloroethylene | 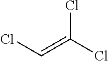 | ~5.5Å | 5.5-11Å | 11-55Å | hydrophobic (2.5) |
| DCE dichloroethylene | 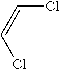 | ~5.1Å | 5.1-10Å | 10-51Å | moderately hydrophobic (1.5) |
| VC Vinyl chloride | 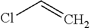 | ~4.7Å | 4.7-9.4Å | 9.4-47Å | moderately hydrophobic (~1.6) |

Sequestration and transport pores are typically defined to be about 1-2 times and up to about 10 times the constituent's molecular diameter, respectively. The hydrophobicity of the constituent is approximated by the octanol-water partitioning coefficient (log K_{ow}), with the lower value of the coefficient representing lower hydrophobicity.

The adsorption capacity of three ACs manufactured from different base raw materials were evaluated using batch isotherm testing: a coconut-based AC, a bituminous-based AC, and a lignite-based AC. The ACs were sized to a D50_{V} particle size of 1-2 μm then subjected to a standard laboratory isotherm test. AC properties were also measured as exhibited in Table 2. Iodine number and nitrogen porosimetry pore size and volume distribution give an indication of available adsorption sites. The ASTM pH, normalized cationic functionality, and normalized surface oxygen functionality represent the receptivity of the AC surface to attract and sequester the constituents of interest. For a less hydrophobic/more polar molecule, the surface charge may be particularly important for attracting negatively polar species such as CVOCs. An AC surface with less oxygen functional groups may be more hydrophobic attracting hydrophobic constituents.

TABLE 18
Properties of activated carbons tested.

| AC Property | Lignite AC | Coconut AC | Bituminous AC |
|---|---|---|---|
| Iodine Number (mg/g) | 500 | 1300 | 1000 |
| ASTM pH | 12.1 | 9.7 | 10.3 |
| Total Pore Volume < 500 Å | Medium | High | Medium |
| (cm³/gram) | | | |
| Micropores for Sequestration | Low | High | Medium |
| (cm³/gram) | | | |
| Small Mesopores for Transport | High | Low | Medium |
| (cm³/gram) | | | |
| Cationic Functionality | High | Low | Medium |
| Surface Oxygen Functionality | Medium | Medium | Low |

Tests were carried out using synthetic groundwater in 250 mL amber jars with PTFE-lined septa caps. The synthetic groundwater consisted of deionized water with about 350 mg/L (ppm) total dissolved solids as instant ocean sea salt and about 100 mg/L of sodium azide to restrict biological growth. All jars were dosed with about 1 mg/L (ppm) of each tetrachloroethene (PCE), trichloroethene (TCE), dichloroethane (DCE), and vinyl chloride (VC). Six dosages of each carbon were used. The jars were allowed to mix on a shaker table for two weeks to allow for equilibrium to be reached, then samples were removed from the mechanical shaker and filtered with a less than 0.45 μm syringe filter. Water samples were analyzed via high resolution GC-MS by method 8260B. Method blanks, laboratory control samples, and surrogate compounds were used.

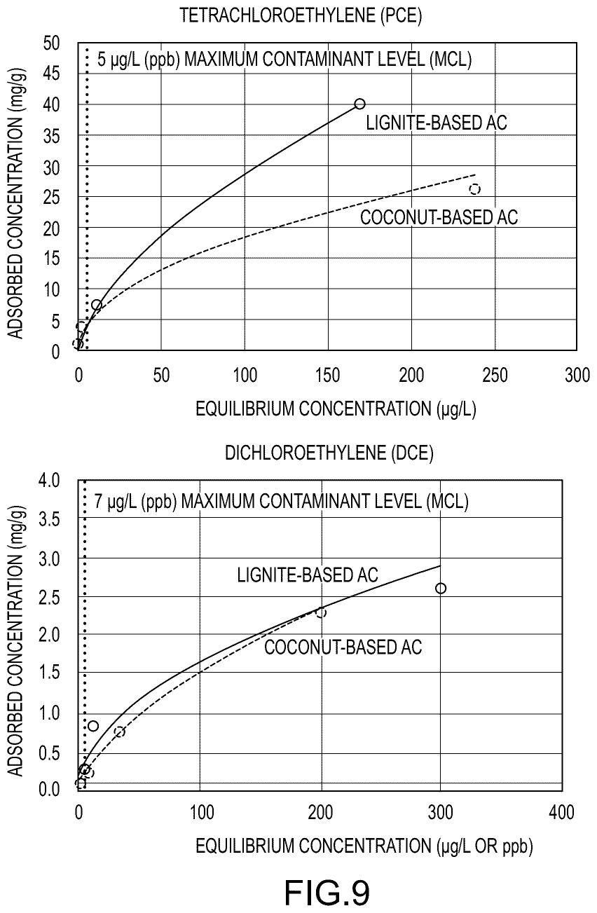

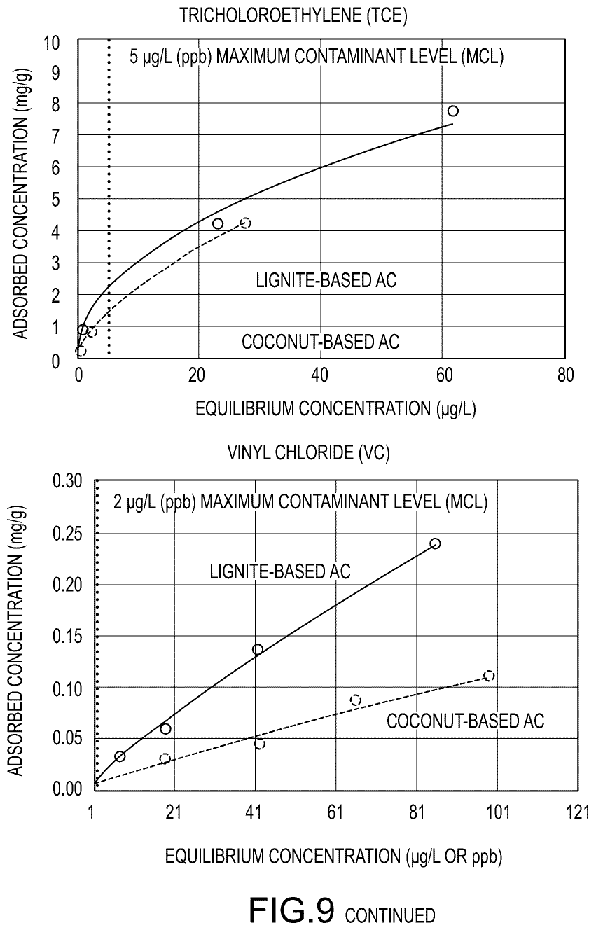

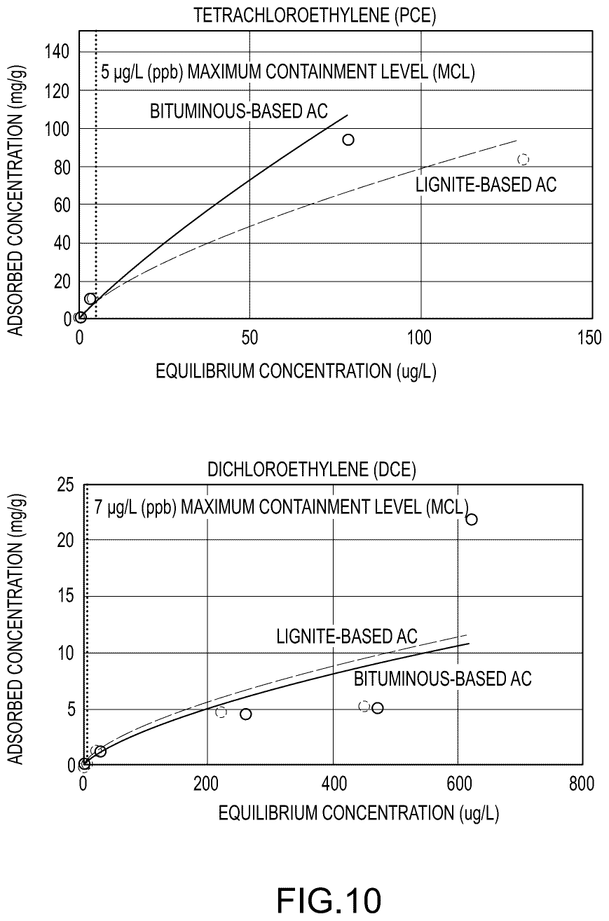

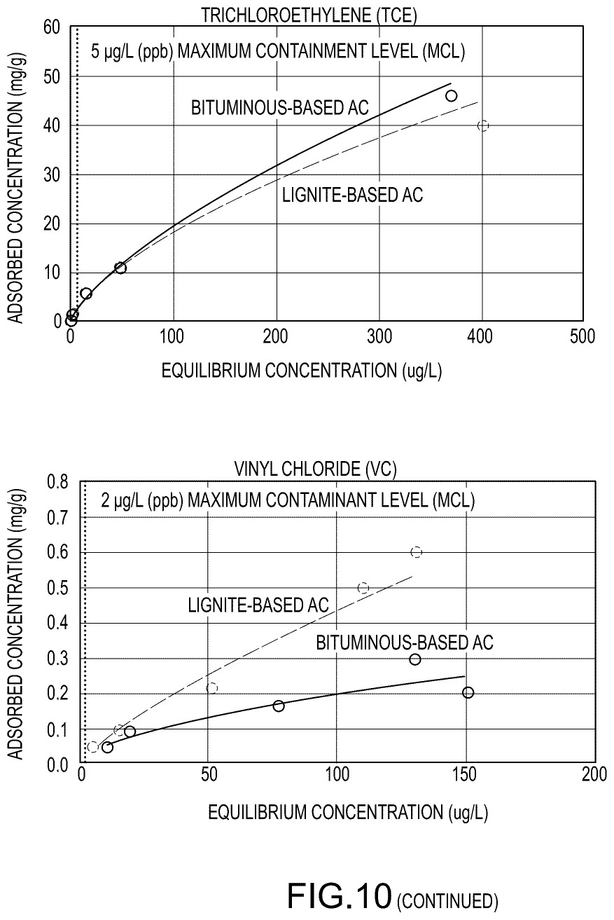

FIGS. 9 and 10 display batch adsorption testing results as isotherm plots. A Freundlich isotherm model was established for each contaminate/AC pair (power line of best fit to correlate the adsorbed constituent concentration on the AC to the concentration still in the water phase at equilibrium).

Adsorption performance is highly dependent on the different properties inherent from AC type as well as the constituent of interest and the concentration of the constituent of interest. To quantify performance comparisons between AC types at environmentally relevant concentrations, a reference equilibrium concentration is chosen. The Maximum Contaminant Level (MCL) was chosen for PCE, TCE, and DCE. To remain within the range of analytical data, an equilibrium concentration of 30 μg/L was chosen as the reference for VC. Then, a performance factor was calculated as the ratio of the adsorbed concentration for the lignite AC carbon to the AC of interest at the reference equilibrium concentration. The performance factor for the reference AC (lignite) is 1.0. The units of the performance factor are weight of the AC of interest per weight of the lignite AC needed to achieve the same target contaminant equilibrium concentration. For example, a performance factor of 3.0 for vinyl chloride indicates that dosage of coconut AC needed to achieve the same equilibrium concentration is approximately 3 times higher than the dosage of lignite AC needed.

TABLE 19
Performance factors or dosage relative to lignite dosage
needed to achieve the same target contaminant equilibrium
concentration for all constituents and activated carbons.

| | | Target | Lignite dose | Bituminous | Coconut |
|---|---|---|---|---|---|
| | Initial | Equilibrium | relative to | dose relative | dose relative |
| Constituent | Concentration | Concentration | lignite | to lignite | to lignite |
| PCE | 1000 μg/L | 5 μg/L (MCL) | 1.0 X | 0.9 X | 1.1 X |
| TCE | 1000 μg/L | 5 μg/L (MCL) | 1.0 X | 1.1 X | 1.5 X |
| DCE | 1000 μg/L | 7 μg/L (MCL) | 1.0 X | 1.3 X | 1.5 X |
| VC | 1000 μg/L | 30 μg/L | 1.0 X | 1.7 X | 3.0 X |

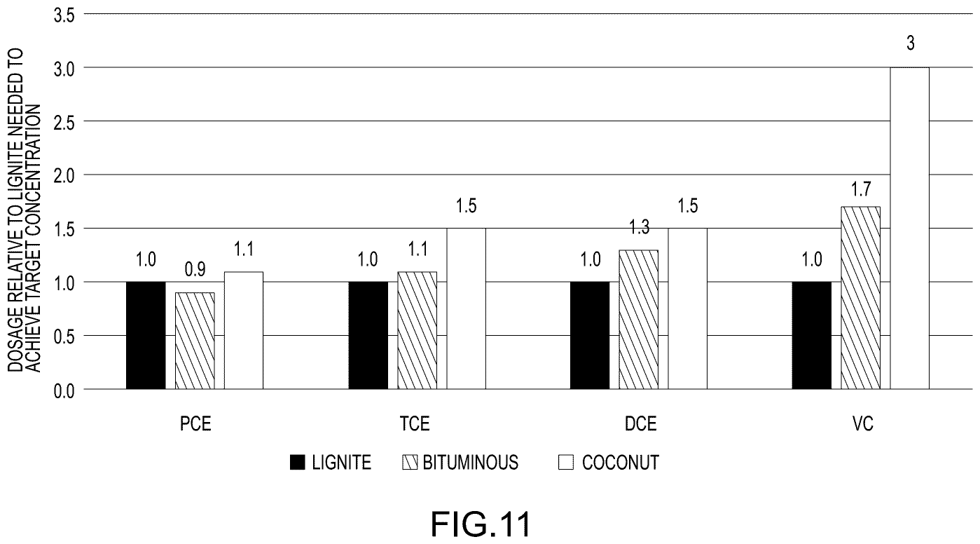

For CVOCs, there is a trend of increasing performance advantage of the lignite AC as the CVOC constituents get less hydrophobic, as demonstrated in Table 19 and FIG. 11. The less hydrophobic constituents are also the more difficult to sequester and have lower total adsorption capacity on a particular AC. Generally, the performance ranking from most effective or lowest dosage rate to least effective or the highest dosage is as follows lignite>bituminous>coconut, concurring with a trend of increasing ASTM pH and cationic surface functionality. The trend is opposite of what would otherwise be observed if adsorption was controlled purely by sequestration or total pore volume. Instead, indicating that AC surface chemistry is also important for driving enhance adsorption performance for CVOC constituents.

In designing ACs for maximum adsorption capacity and selectivity for CVOCs, traditional AC properties, such as total pore volume, surface area, and iodine number, are important but are not fully indicative of adsorption performance for CVOC constituents. Instead, adsorption also is enhanced through additional AC properties, such as surface functionalities that attract the constituents of interest and the presence of transport pores that improve adsorption diffusion kinetics. While an AC with a higher concentration of sequestration pores (1-2× the molecular diameter of the target constituent) may have more potential adsorption sites, only a very small percentage of sequestration pores are utilized when constituent concentrations are low. This makes not just the number but also the characteristic of the sequestration pores critical in creating high energy adsorption sites suitable for sequestering trace contaminants. In addition, transport pores (up to 10× the diameter of the target constituent) may be important. These pores serve to funnel the constituent of interest to sequestration pores, to improve adsorption kinetics, and to moderate the impacts of competitive adsorption.

Superior performance of lignite AC was identified especially for less hydrophobic and/or more polar CVOCs indicating a selectivity for these more difficult to remove contaminants. The properties of the AC surface of this lignite AC, particularly the positively charged functionality, enhanced the adsorption selectivity for the more negatively polar species. The transport pores also may serve to minimize the impact of competitive adsorption from more strongly adsorbing and/or more hydrophobic constituents.

Results from these lab batch tests give quantitative trends in adsorption performance of CVOCs to the ACs tested. Specific adsorption capacities at a remediation site will vary based on site-specific conditions such as background water quality and relative concentrations of competing contaminants. None-the-less, these results highlight the importance of tuning AC porosity and surface characteristics in controlling adsorption performance. AC functionalities responsible for controlling the CVOC capture mechanisms can be engineered onto a range of AC base materials.

### Example 13: Activated Carbon for Adsorbing PFAS

The goal of this work was to evaluate the capacity and selectivity of different base ACs for adsorbing common Per and Polyfluoroalkyl Substances (PFAS) and to garner a greater understanding of driving mechanisms for adsorption of PFAS. Results shared in this summary are the first in a larger program evaluating PFAS adsorption to ACs. A breakdown of common PFAS properties and associated AC features are shown in Table 20.

TABLE 20
PFAS examples and associated AC features.

| | | | Sequestration | Transport | | |
|---|---|---|---|---|---|---|
| | | | Pore Width | Pore Width | | |
| | | Molecular | (1-2× molecular | (up to 10× molecular | | Hydrophobicity |
| | | Size | diameter) | diameter) | Charge | (log K_{ow}) |
| PFOA [symbol] | 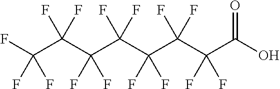 [SMILES: O=C(O)C(F)(F)C(F)(F)C(F)(F)C(F)(F)C(F)(F)C(F)(F)C(F)(F)F] | 8 × 13Å | 8-26Å | 26-130Å | Netative under most pH conditions | hydrophobic (3.1) |
| PFOS [symbol] | 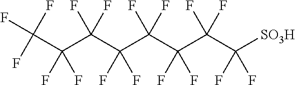 [SMILES: O=S(=O)(O)C(F)(F)C(F)(F)C(F)(F)C(F)(F)C(F)(F)C(F)(F)C(F)(F)C(F)(F)F] | 8 × 13Å | 8-26Å | 26-130Å | Negative under most pH conditions | Very hydrophobic (5.6) |
| PFBS [symbol] | 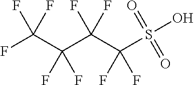 [SMILES: O=S(=O)(O)C(F)(F)C(F)(F)C(F)(F)C(F)(F)F] | 7 × 10Å | 7-20Å | 20-100Å | Negative under most pH conditions | hydrophobic (2.6) |

[symbol]

indicates data missing or illegible when filed

Sequestration and transport pores are defined to be about 1-2 times and up to about 10 times the constituent's molecular diameter, respectively. The hydrophobicity of the constituent is approximated by the octanol-water partitioning coefficient (log K_{ow}), with the lower value of the coefficient representing lower hydrophobicity.

The adsorption capacity of three ACs manufactured from different base raw materials were evaluated using batch isotherm testing: a coconut-based AC, a bituminous-based AC, and a lignite-based AC. The ACs were sized to a D50_{V} particle size of about 1-2 μm then subjected to a standard laboratory isotherm test. AC properties also were measured as exhibited in Table 21. Iodine number and nitrogen porosimetry pore size and volume distribution give an indication of available adsorption sites. The ASTM pH, cationic functionality, and surface oxygen functionality represent the receptivity of the AC surface to attract and sequester the constituents of interest. The surface charge may be particularly important for attracting negatively charged species such as PFAS. An AC surface with less oxygen functional groups may be advantageous in creating a hydrophobic surface to attract the PFAS hydrophobic tail.

TABLE 21
Properties of the AC's tested.

| AC Property | Lignite AC | Coconut AC | Bituminous AC |
|---|---|---|---|
| Iodine Number (mg/g) | 500 | 1300 | 1000 |
| ASTM pH | 12.1 | 9.7 | 10.3 |
| Total Pore Volume < 500 Å | Medium | High | Medium |
| (cm³/gram) | | | |
| Micropores for Sequestration | Low | High | Medium |
| (cm³/gram) | | | |
| Small Mesopores for Transport | High | Low | Medium |
| (cm³/gram) | | | |
| Cationic Functionality | High | Low | Medium |
| Surface Oxygen Functionality | Medium | Medium | Low |

Single-solute PFAS adsorption tests were conducted for two long-long chain PFAS compounds (perfluorooctanoic acid (PFOA), perfluorooctanesulfonic acid (PFOS)) and one short-chain PFAS compound (perflourobutanesulfonic acid (PFBS)). Tests were carried out using synthetic groundwater in 10 mL polypropylene bottles. The synthetic groundwater consisted of deionized water with about 370 mg/L (ppm) total dissolved solids as instant ocean sea salt. Bottles were each dosed with about 10 mg AC and about 7 initial PFAS concentrations were used. The jars were allowed to mix on a shaker table for 3 days. Then, samples were removed from the mechanical shaker, centrifuged, and filtered with a less than 0.2 μm syringe filter. Water samples were analyzed via high resolution LC-MS/MS.

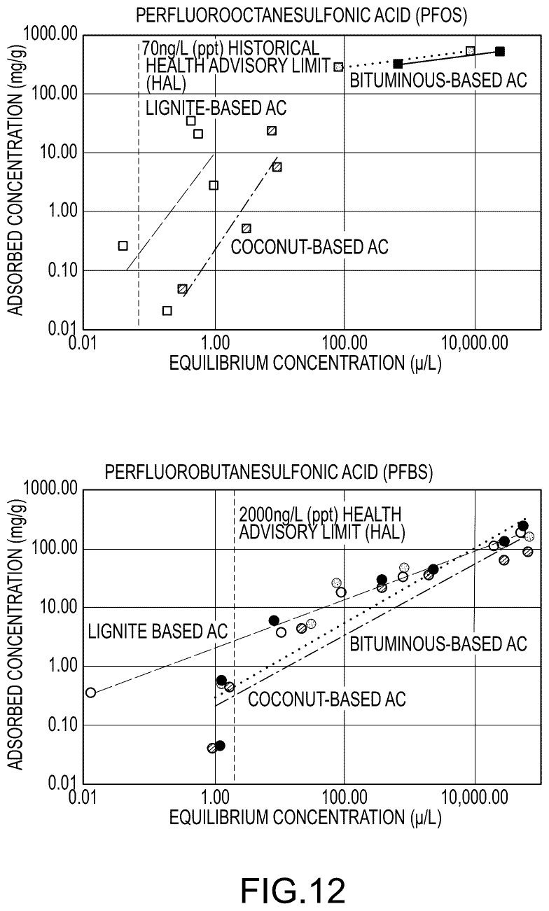

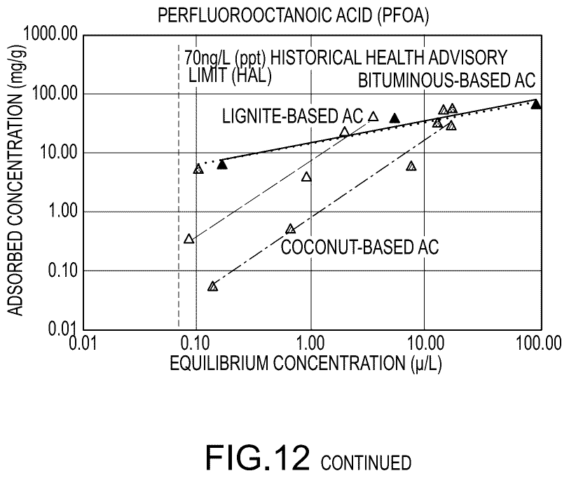

FIG. 12 depicts batch adsorption testing results as isotherm plots. A Freundlich isotherm model was established for each contaminate and AC pair (power line of best fit to correlate the adsorbed constituent concentration on the AC to the concentration still in the water phase at equilibrium). The plots of FIG. 12 are displayed on a log-log scale. Additional tests are on-going to better quantify adsorption performance in the low-concentration range. Additional PFOS data points for the bituminous AC were non-detect.

Adsorption performance is highly dependent on the different AC properties as well as the constituent of interest and the concentration of the constituent of interest. To quantify performance comparisons, environmentally relevant reference equilibrium concentrations were chosen. The Health Advisory Limit (HAL) was used to compare performance for PFBS and the historical HALs were used for PFOS and PFOA. Then, a performance factor was calculated as the ratio of the adsorbed concentration for the bituminous AC carbon to the AC of interest at the reference equilibrium concentration. The performance factor for the reference AC (bituminous) is 1.0. The units of the performance factor are weight of the AC of interest per weight of the bituminous AC needed to achieve the same target contaminant equilibrium concentration. For example, a performance factor of >25 for PFOS and PFOA indicates that dosage of coconut AC needed to achieve the same equilibrium concentration is greater than 25 times higher than the dosage of bituminous AC needed. Conversely, a performance factor of 0.2 for PFBS indicates that 80% less lignite AC compared to bituminous AC can be used to reach the PFBS HAL.

TABLE 22
Performance factors or dosage relative to bituminous dosage needed
to achieve the same target contaminant equilibrium
concentration for all constituents and activated carbons.

| | Target | Bituminous | Lignite dose | Coconut dose |
|---|---|---|---|---|
| | Equilibrium | dose relative | relative to | relative to |
| Constituent | Concentration | to bituminous | bituminous | bituminous |
| PFOS | 70 ng/L | 1.0 X | >25 X | >25 X |
| | (Historical HAL) | | | |
| PFOA | 70 ng/L | 1.0 X | >25 X | >25 X |
| | (Historical HAL) | | | |
| PFBS | 2000 ng/L (HAL) | 1.0 X | 0.2 X | 1.5 X |

There are two distinct performance trends for each long-chain (PFOS and PFOA) versus short-chain (PFBS) constituents. The long-chain PFAS compounds are more hydrophobic and more adsorbable by AC. Generally, the performance ranking for the long-chain compounds from most effective or lowest dosage rate to least effective or the highest dosage is as follows bituminous>lignite>coconut. The trend does not track what would be observed if adsorption was controlled by sequestration or total pore volume, instead indicating that performance is controlled by a combination of factors including surface chemistry. For the short chain compound, performance of lignite is superior to both bituminous and coconut, indicating an even larger dependence on surface chemistry of the AC for the less hydrophobic/more charged compounds.

In designing ACs for maximum adsorption capacity and selectivity for PFAS, traditional AC properties, such as total pore volume, surface area, and iodine number, are important but are not fully indicative of adsorption performance. Instead, adsorption also is enhanced through additional AC properties, such as surface functionalities that attract the constituents of interest and the presence of transport pores that improve adsorption diffusion kinetics. While an AC with a higher concentration of sequestration pores (1-2× the molecular diameter of the target constituent) may have more potential adsorption sites, only a very small percentage of sequestration pores are utilized when constituent concentrations are low. This makes not just the number but also the characteristic of the sequestration pores critical in creating high energy adsorption sites suitable for sequestering trace contaminants. In addition, transport pores (up to 10× the diameter of the target constituent) may be important. These pores serve to funnel the constituent of interest to sequestration pores, to improve adsorption kinetics, and to moderate the impacts of competitive adsorption.

Superior performance of bituminous AC was identified for long-chain PFAS compounds. The properties of this AC, particularly the highly hydrophobic surface (low concentration of surface oxygen functional groups), may be important for driving enhanced adsorption of these hydrophobic long-chain PFAS. Superior performance of lignite AC was identified for PFBS indicating a selectivity for more difficult to adsorb short-chain compounds. The properties of the lignite AC surface, particularly the positively charged functionality, enhanced the adsorption selectivity for the more highly charged/less hydrophobic PFBS. In both cases, the transport pores also may also be advantageous.

Results from these lab batch tests give quantitative trends in adsorption performance of PFAS to the ACs tested. Specific adsorption capacities at a remediation site will vary based on site-specific conditions such as background water quality and relative concentrations of competing contaminants. None-the-less, these results highlight the importance of tuning AC porosity and surface characteristics in controlling adsorption performance. AC functionalities responsible for controlling the PFAS capture mechanisms can be custom engineered onto a range of AC base materials.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A multi-functionalized activated carbon sorbent comprising activated carbon particles, wherein:
at least about 50% by weight of the activated carbon particles are less than about 2 micrometers,
at least about 90% by weight of the activated carbon particles are less than about 4 micrometers,
a particle number density of the multi-functionalized activated carbon sorbent is at least about a trillion particles per gram, and
the external surface area density is at least about 1.5 square meters per gram.

2. The multi-functionalized activated carbon sorbent of claim 1, comprising at least about 50 wt. % but not greater than about 95 wt. % of fixed carbon.

3. The multi-functionalized activated carbon sorbent of claim 1, comprising at least about 50 wt. % but not greater than about 80 wt. % of fixed carbon.

4. The multi-functionalized activated carbon sorbent of claim 1, comprising at least about 1.5 wt. % but not greater than 50 wt. % of minerals.

5. The multi-functionalized activated carbon sorbent of claim 1, comprising at least about 10 wt. % but not greater than 50 wt. % of minerals.

6. The multi-functionalized activated carbon sorbent of claim 1, comprising at least about 1 wt. % iron, at least about 1 wt. % calcium, and at least about 500 mg/kg titanium, on a dry weight basis.

7. The multi-functionalized activated carbon sorbent of claim 1, wherein a sum of micropore volume plus mesopore volume of the activated carbon particles is at least about 0.2 cc/g.

8. The multi-functionalized activated carbon sorbent of claim 1, wherein a ratio of micropore volume-to-mesopore volume of the activated carbon particles is at least about 0.45 but not greater than about 1.9.

9. The multi-functionalized activated carbon sorbent of claim 1, wherein a ratio of micropore volume-to-mesopore volume of the activated carbon particles is at least about 0.45 but not greater than about 1.0.

10. The multi-functionalized activated carbon sorbent of claim 1, wherein a nitrogen-to-carbon mass ratio of the activated carbon particles is at least about 3.2-to-1000, on a dry weight basis.

11. The multi-functionalized activated carbon sorbent of claim 1, wherein a nitrogen-to-carbon mass ratio of the activated carbon particles is at least about 5.0-to-1000, on a dry weight basis.

12. The multi-functionalized activated carbon sorbent of claim 1, wherein a thermogravimetric analysis (TGA) weight loss of the activated carbon particles, between about 400-750° C., is less than about 4 weight percent.

13. The multi-functionalized activated carbon sorbent of claim 1, wherein a thermogravimetric analysis (TGA) weight loss of the activated carbon particles is less than about 2 weight percent between about 400-750° C., and is at least about 1 wt. % between about 750-900° C.

14-17. (canceled)

18. The multi-functionalized activated carbon sorbent of claim 1, comprising water, and between about 5 and 25 wt. % of the activated carbon particles.

19. The multi-functionalized activated carbon sorbent of claim 1, comprising about 100 wt. % of the activated carbon particles.

20. The multi-functionalized activated carbon sorbent of claim 1, comprising one or more of a nitrogen functionalized organic compound and a rheology additive.

21. A multi-functionalized activated carbon sorbent comprising activated carbon particles and a nitrogen functionalized organic compound, wherein:
the nitrogen-functionalized organic compound hosts a positive charge throughout the pH range above about 8 pH units, and
the nitrogen of the nitrogen functionalized organic compound links with at least two adjoining carbon atoms.

22. The multi-functionalized activated carbon sorbent of claim 21, wherein the ball pan hardness of the multi-functionalized activated carbon sorbent is less than about 98.

23. The multi-functionalized activated carbon sorbent of claim 21, wherein the ball pan hardness of the multi-functionalized activated carbon sorbent is less than about 75.

24-35. (canceled)

36. The multi-functionalized activated carbon sorbent of claim 21, wherein the molecular weight of the nitrogen-functionalized organic compound is less than about 8,000 Daltons.

37. The multi-functionalized activated carbon sorbent of claim 21, wherein the nitrogen-functionalized organic compound is selected from the group consisting of pyridine, pyridinium, quaternary ammonium, pyrrole, imines, pyrrolic nitrogen, imides, pyridinic nitrogen, secondary amine, tertiary amine, primary ketimine, secondary ketimine, primary aldimine, secondary aldimine, azide, azo compounds, pyridyl, hemoglobin, porphyrin, amine oxide and/or mixtures thereof.

38. The multi-functionalized activated carbon sorbent of claim 21, wherein the nitrogen-functionalized organic compound has a molecular weight of greater than about 200 Daltons.

39. The multi-functionalized activated carbon sorbent of claim 21, wherein the mass ratio of the activated carbon particles to the nitrogen-functionalized organic compound is between about 0.95:0.05 and about 0.05:0.95.

40. The multi-functionalized activated carbon sorbent of claim 21, wherein the mass ratio of the activated carbon particles to the nitrogen-functionalized organic compound is between about 0.9:0.1 and about 0.05:0.95.

41. The multi-functionalized activated carbon sorbent of claim 21, wherein the mass ratio of the activated carbon particles to the nitrogen-functionalized organic compound is between about 0.9:0.1 and about 0.25:0.75.

42. The multi-functionalized activated carbon sorbent of claim 21, wherein the mass ratio of the activated carbon particles to the nitrogen-functionalized organic compound is between about 0.75:0.35 and about 0.25:0.75.

43. The multi-functionalized activated carbon sorbent of claim 21, wherein the carrier ion of the nitrogen-functionalized organic compound is chloride, bromide, fluoride, iodide, methyl sulfate, or a combination thereof.

44. The multi-functionalized activated carbon sorbent of claim 21, wherein the nitrogen-functionalized organic compound comprises an alkyl tail with between 6 and 24 carbon atoms.

45-48. (canceled)

49. The multi-functionalized activated carbon sorbent of claim 21, wherein at least about 50% by weight of the activated carbon particles are less than about 7 to 50 micrometers.

50. The multi-functionalized activated carbon sorbent of claim 21, wherein at least about 50% by weight of the activated carbon particles are between about 200 to 5000 micrometers.

51. The multi-functionalized activated carbon sorbent of claim 21, wherein at least about 50% by weight of the activated carbon particles are less than about 2 micrometers.

52. The multi-functionalized activated carbon sorbent of claim 51, wherein at least about 90% by weight of the activated carbon particles are less than about 4 micrometers.

53. The multi-functionalized activated carbon sorbent of claim 52, wherein a particle number density of the multi-functionalized activated carbon sorbent is at least about a trillion particles per gram.

54. The multi-functionalized activated carbon sorbent of claim 53, wherein the external surface area density is at least about 1.5 square meters per gram.

55. The multi-functionalized activated carbon sorbent of claim 21, comprising water, and between about 15 and 40 wt. % of the activated carbon particles.

56. (canceled)

57. The multi-functionalized activated carbon sorbent of claim 21, comprising at least 90 wt. % of the activated carbon particles.

58. (canceled)

59. The multi-functionalized activated carbon sorbent of claim 21, comprising a rheology additive.

60. A multi-functionalized activated carbon sorbent comprising activated carbon particles and a rheology additive, wherein:
at least about 50% by weight of the activated carbon particles are less than about 2 micrometers,
at least about 90% by weight of the activated carbon particles are less than about 4 micrometers,
a particle number density of the multi-functionalized activated carbon sorbent is at least about a trillion particles per gram, and
the external surface area density is at least about 1.5 square meters per gram.

61. The multi-functionalized activated carbon sorbent of claim 60, comprising a nitrogen functionalized organic compound.

62. The multi-functionalized activated carbon sorbent of claim 60, wherein the rheology additive is utilized at a mass ratio of activated carbon particles to rheology additive between about 0.95:0.05 and about 0.50:0.50.

63. The multi-functionalized activated carbon sorbent of claim 60, wherein the rheology additive and activated carbon particles are in a solution comprising about 15 wt. % of the activated carbon particles and about 3 wt. % of the rheology additive.

64. The multi-functionalized activated carbon sorbent of claim 60, wherein the rheology additive is utilized at mass ratio of activated carbon particles to multi-functional rheology additive between about 0.90:0.10 and about 0.70:0.30.

65. The multi-functionalized activated carbon sorbent of claim 60, wherein the rheology additive is selected from the group comprising carboxymethyl cellulose (CMC), petroleum sulfonates, polyacrylates, polycarboxylates, polynaphthalene sulfonates, sodium lignosulfonates, Hydroxy ethyl cellulose (HEC), Methyl cellulose (MC), Methyl hydroxy ethyl cellulose (MHEC), hydroxy propyl methyl cellulose (HPMC), Hydroxy propyle cellulose (HPC), Ethyl cellulose (EC), Carbomer (polyacrylic acid), and Guar.

66.-112. (canceled)
